(19) United States
(12) Patent Application Publication
(10) Pub. No.: US 2026/0161904 A1
(43) Pub. Date: Jun. 11, 2026

(54) METHODS AND ARRANGEMENTS FOR SONIC SIGNALING VIA A CHIP CARD

(71) Applicant: Capital One Services, LLC, McLean, VA (US)

(72) Inventors: Ryan Horne, McLean, VA (US); Kevin Osborn, Newton Highlands, MA (US)

(73) Assignee: Capital One Services, LLC, McLean, VA (US)

(21) Appl. No.: 18/971,197

(22) Filed: Dec. 6, 2024

(51) Int. Cl. G06K 7/02; G06K 19/04; G06K 19/07

(52) U.S. Cl. CPC G06K 7/02; G06K 19/045; G06K 19/0707; G06K 19/0715

(57) ABSTRACT

Embodiments may include a chip card having sound signaling circuitry, a power storage device, and a transducer to generate sound pulses intermittently or periodically for receipt by a mobile device to assist a client to find the chip card when misplaced or lost or help the client to find the mobile device when misplaced or lost. Logic of the chip card may detect a first trigger event, wherein the first trigger event comprises disconnection of a source of power to charge the power storage device, loss of communication with a mobile device, or completion of a transaction. Logic of the chip card may cause application of intermittent or periodic power pulses to the transducer to generate sound pulses based on power stored in the power storage device after the first trigger event. Logic of the mobile device may detect the sound pulses and display a representation of the intensity thereof.

### BACKGROUND

A chip card may be a contacted card, a contactless card, or a card with both contacted and contactless technologies that include a chip such as a processor, a microcontroller, or the like. References to contactless cards often refer to chip cards that may optionally include contacts and include a near field communication (NFC) technology integrated with the chip or coupled with the chip to communicate with a terminal.

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to clients through credit card issuers (such as banks and other financial institutions). With a card, an authorized client or cardholder is capable of purchasing services and/or merchandise without an immediate, direct exchange of cash. Data security and transaction integrity are of critical importance to businesses facilitating these transactions and to the clients. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless card.

### BRIEF SUMMARY

In one aspect, a chip card, includes an antenna, a power storage device such as a capacitor, a battery, or a combination of the capacitor and the battery, a transducer, and memory comprising one or more applets. The chip card also includes a processor coupled with the memory, the antenna, the power storage device, and the transducer, the processor to execute instructions of the one or more applets to perform operations to detect a first trigger event, where the first trigger event includes disconnection of a source of power to charge the power storage device, loss of communication with a mobile device, or completion of a transaction, and cause application of periodic power pulses to the transducer to generate ultrasonic signals based on power stored in the power storage device after the first trigger event. The one or more applets may comprise a metal detection applet, the processor to execute the metal detection applet to generate an electromagnetic frequency (EMF) signal, to receive reflections of the EMF signal from a conductive metal shield via the antenna, and to determine, based on received signals, that the received signals comprise reflections of the EMF signal off the conductive metal shield.

The chip card may further include a communications interface, where the communications interface includes a near field communications interface, a contacted communications interface, a wireless communications interface, or a combination thereof. The chip card may further determine a second trigger event, the second trigger event based on a power threshold of the power storage device, where the processor reduces a frequency of the periodic power pulses to the transducer to reduce power consumption. Other technical features may be readily apparent to one skilled in the art from the following figures, descriptions, and claims.

In one aspect, a mobile device, includes a microphone, a display, a speaker, and memory comprising one or more applets. The mobile device may also includes a processor coupled with the microphone, the display, and the memory to execute the one or more applets to perform operations to monitor the microphone for ultrasonic pulses from a chip card; determine, based on receipt of the ultrasonic pulses, variations in an intensity of the ultrasonic pulses; and generate a representation of the variations in the intensity of the ultrasonic pulses, the representation includes a visual representation, an audible representation, or a combination thereof.

The mobile device may also present the representation via the display, the speaker, or a combination thereof. The processor may perform operations to further determine, based on a periodicity of the ultrasonic pulses, that the ultrasonic pulses are generated by the chip card. The mobile device may also include further includes a communications interface, the operations to further detect a presence of the chip card in proximity to the mobile device via the communications interface, determine a location of the mobile device via a location device or an applet, and store an indication of the location in the memory. Other technical features may be readily apparent to one skilled in the art from the following figures, descriptions, and claims.

In one aspect, a computer-implemented method, may involve determining, by a processor of a chip card executing an applet from memory coupled with the processor, an occurrence of a first trigger event, where the first trigger event includes disconnection of a source of power to charge a power storage device, loss of communication with a mobile device, or completion of a transaction, and causing application of periodic current pulses to a transducer to generate periodic ultrasonic signals via on power stored in the power storage device after the occurrence of the first trigger event. The computer-implemented method may further involve executing a metal detection applet to generate an electromagnetic frequency (EMF) signal, to receive reflections of the EMF signal from a conductive metal shield via an antenna coupled with the processor, and to determine, based on received signals, that the received signals comprise reflections of the EMF signal off the conductive metal shield.

The computer-implemented method may further involve determining that the chip card is proximate to the mobile device via a wireless communication interface coupled with the processor, on the chip card. Other technical features may be readily apparent to one skilled in the art from the following figures, descriptions, and claims.

### BRIEF DESCRIPTION OF THE SEVERAL VIEWS OF THE DRAWINGS

FIG. 1 illustrates an embodiment of a system in accordance with one embodiment.

FIG. 2 illustrates another an embodiment of a system in accordance with one embodiment.

FIG. 3 illustrates an embodiment of a flowchart for a process in accordance with one embodiment.

FIG. 4 illustrates another embodiment of a flowchart for a process in accordance with one embodiment.

FIG. 5 illustrates another embodiment of a flowchart for a process in accordance with one embodiment.

FIG. 6 illustrates an example of a system configured to operate in accordance with embodiments discussed herein.

FIG. 7 illustrates an embodiment of a communications sequence in accordance with one embodiment.

FIG. 8A illustrates another embodiment of a communications sequence in accordance with one embodiment.

FIG. 8B illustrates another embodiment of a communications sequence in accordance with one embodiment.

FIG. 8C illustrates another embodiment of a communications sequence in accordance with one embodiment.

FIG. 9 illustrates an example of a message that may be communicated by a contactless card in accordance with one embodiment.

FIG. 10 is a flow chart illustrating various operations of an example method in accordance with one embodiment.

FIG. 11 illustrates an embodiment of a distributed network authentication system in accordance with one embodiment.

FIG. 12 illustrates an embodiment of a method performed by a distributed network authentication system in accordance with one embodiment.

FIG. 13 illustrates an embodiment of a data transmission system in accordance with one embodiment.

FIG. 14 illustrates an embodiment of a contactless card in accordance with one embodiment.

FIG. 15 illustrates an embodiment of a transaction card component in accordance with one embodiment.

FIG. 16 illustrates an embodiment of a timing diagram in accordance with one embodiment.

### DETAILED DESCRIPTION

Embodiments may implement sonic signaling to address problems related to losing, misplacing, or leaving a chip card or mobile device at a location that is not easy to find. Such situations may be more prevalent after a transaction while a client is distracted by other matters. For instance, after paying for a meal at a restaurant, a distracted client may inadvertently leave their credit card in a card holder or a mobile device on the table instead of returning the credit card to a wallet or purse or the mobile device to a pocket or carrier. When hurrying to exit a store, a client may inadvertently leave a chip card or a mobile device on the counter next to the transaction terminal. When struggling to pickup and carry a large amount of items in a store, the store clerk may help the client to gather the items and both the distracted store clerk and the distracted client may forget about returning the chip card to the client or the client may sit a mobile device on the counter and forget to pick it up. Once the client leaves the area and the store clerk and/or other client may be unable to determine how to contact the client that left without the chip card or the mobile device.

In such situations, embodiments described herein may advantageously use the mobile device to locate the chip card or use the chip card to alarm the user about leaving the mobile device or the chip card at, e.g., the restaurant or the store. Embodiments herein may advantageously implement sonic signaling by a chip card to communicate with a mobile. For instance, due to improvements in capacitors and/or thin batteries, a credit card sized (or similar sized) chip card may incorporate one or more capacitors and/or thin batteries to power sonic signaling circuitry of the chip card to generate repeated sound pulses (e.g., chirps or pings) that can be received via sensors such as a microphone and a sound signaling application on a mobile device. Based on the detection of the sound pulses, the mobile device may assist a client to find the chip card or the mobile device and/or notify the client about the chip card or mobile device before the client wanders to far from the chip card or mobile device.

In some embodiments, the sound pulses may be inaudible to humans, or outside the audible range for humans. For example, the frequency of the sonic signaling may be above 20 kilohertz (Khz) whereas the audible range of sound for humans is about 20 hertz (Hz) and 20 KHz. In many embodiments, the chip card may include sound signaling circuitry to generate the sound pulses by applying pulses of power to a transducer such as an ultrasonic transducer. Transducers may be devices that convert electrical energy into sound or vice versa. Ultrasonic transducers may be devices that convert electrical energy into ultrasonic sound. By repeatedly, intermittently, or periodically applying pulses of power to a transducer, the transducer may repeatedly, intermittently, or periodically produce sound pulses, which may be ultrasonic pulses (or ultrasonic signals).

In some embodiments, the sound signaling circuitry of a chip card may produce sound pulses patterns that may distinguish a client's chip card from another chip card in the area of the client's chip card. By communicating or initializing a pattern of sound pulses with a sound signaling application on a mobile device, the mobile device may identify sound pulses from the client's chip card or distinguish sound pulses from the client's chip card from sound pulses of other chip cards.

In some embodiments, a transducer on the chip card may be a piezo-electric transducer built with a piezo-electric material such as a crystal, a ceramic, or a film. The shape, volume, and piezo-electric material of the piezo-electric device may determine the resonant frequency and amplitude of the sound pulses responsive to application of the power pulse to the transducer. The voltage applied to the piezo-electric material may affect the frequency bandwidth of the sound pulses produced by the piezo-electric transducer. In many embodiments, a piezo-electric driver of the sound signaling circuitry may determine the voltage of the power pulse applied to the piezo-electric material to determine the frequency bandwidth of the pulses. In some embodiments, the voltage applied and/or the shape an volume of the piezo-electric material may vary between chip cards to vary the frequency bandwidth of the sound pulses. In such embodiments, a sound signaling application on the mobile device may distinguish sound pulses generated by the client's chip card from sound pulses generated by another client's chip card.

In some embodiments, the sound signaling circuitry of the chip card may comprise an applet executing on a processor of a chip of the chip card. In some embodiments, the sound signaling circuitry of the chip card may comprise specialized circuitry that is distinct from and operates independently of the processor of the chip. In further embodiments, the sound signaling circuitry may comprise a combination of processing circuitry of the processor executing an applet and circuitry that is distinct from the processor. In some embodiments, the sound signaling circuitry may operate independently from a sound signaling applet executing on the processor but the sound signaling applet executing on the processor may be capable of stopping or terminating and/or starting or initiating the application of power pulses to the transducer. For instance, the processor of the chip card may determine when contacts coupled with the processor are coupled with a terminal to perform a transaction, when contacts coupled with the processor are coupled with contacts of a sleeve for the chip card, or when a power storage device is charging from contacts of a terminal or via a wireless power transfer protocol from the terminal or a mobile device. While the contacts are in contact with a terminal or a sleeve for the chip card, the sound signaling applet of the chip card may determine that the sound pulses should be turned off because the chip card may be in the possession of the client. While the power storage device is charging, the sound signaling applet of the chip card may determine that the sound pulses should be turned off because the chip card may be in the possession of the client. While the processor of the chip card determines that the chip card is in proximity to the client's mobile device, the sound signaling applet of the chip card may determine that the sound pulses should be turned off because the chip card may be in the possession of the client.

Embodiments may also include a mobile device executing a sound signaling application. The sound signaling application may execute on a processor of the mobile device in a background to monitor for sound pulses (chirps or pings) produced by the client's chip card or may execute in the foreground, such as after detection of a sound pulse from the chip card. In some embodiments, the sound signaling application of the mobile device may cause the processor of the mobile device to intermittently or periodically determine whether the chip card is in proximity to the mobile device. For instance, the mobile device may intermittently or periodically charge or check a charge (or power) level of the power storage device of the chip card. At each successful contact with the chip card, the mobile device may determine a geographical location of the mobile device and store the location in memory of the mobile device as a last known location of the chip card. In some embodiments, the mobile device may maintain a set of two or more last known locations in the memory of the mobile device as a historical record of locations of the chip card.

In such embodiments, the mobile device, upon detecting a sound pulse from the chip card, may generate an audible alert via a speaker of or connected to the mobile device and/or generate a visual notification for the client on the display of the mobile device. In some embodiments, the visual notification may include or have a link to a map having an indicator to show the last known location of the chip card. In some embodiments, the visual notification may include a pointer such as an arrow or caret (\hat{ }) to indicate the direction of the last known location relative to the current location of the mobile device. In such embodiments, if the client just accidentally left the chip card at a counter or dropped the chip card in the store and the client is still near or inside the store, the client may quickly retrieve the chip card. In other situations, such as when the client left the mobile device on a counter of a store, the audible alert and/or visual notification may notify the store clerk that the client left the mobile device so the store clerk might have a chance to notify the client that the client left the mobile device on the counter. In some embodiments, the sound pulse generated by the chip card may create a haptic response such as a push or vibration that the client may recognize or detect and determine that the mobile device is outside a proximity of the chip card so the client may retrieve the mobile device before traveling far from the store.

In some embodiments, the sound signaling application may include client-selectable preferences related to operations of the mobile device and/or the chip card. For instance, the client may select a preference to initiate an audible alarm and/or a visual notification to notify the client when the mobile device first detects a sound pulse from the chip card. The client may select a preference to initiate an audible alarm and/or a visual notification to notify the client if the chip card is outside a proximity of the mobile device. The client may select a preference to set a time duration for transmission of sound pulses, set a time duration for transmission of sound pulses at a first frequency, set a duration for transmission of sound pulses at a second frequency, set a first threshold power level to switch pulses from a first frequency to a second frequency, set a second threshold power level to switch pulses from the second frequency to a third frequency, a combination thereof, or the like.

In some embodiments, the client may select a preference for setting a periodicity of sending sound pulses. The client may select a preference to establish a trigger event to trigger the sound signaling circuitry of the chip card to send sound pulses after completion of a transaction, establish a trigger event to send sound pulses while the power storage device is not being charged, establish a trigger event to send sound pulses if the chip card is out of range of near field communications with the client's mobile device, establish a trigger event to send sound pulses if the chip card is out of range of Bluetooth® communications with the client's mobile device, establish a trigger event to stop sound pulses if the chip card is proximate to a metal shield such as an radio frequency identifier (RFID) shield, and/or the like.

In some embodiments, may select a preference to establish a trigger event to trigger the sound signaling application of mobile device to display a visual notification with a message after detection of sound pulses from the chip card, establish a trigger event to trigger the sound signaling application of mobile device to output an audible alert after detection of sound pulses from the chip card, establish a trigger event to trigger the sound signaling application of mobile device to display a a map with a last known location for the chip card after detection of sound pulses from the chip card, and/or the like. In some embodiments, the client may set the number of historical locations that the mobile device will maintain along with the last known location. In some embodiments, the client may select one or more preferences related to how to display a signal strength of the sound pulses while the mobile device is receiving sound pulses such as a preference for a numerical representation, a graphical representation, or a combination thereof.

In some embodiments, the chip card is a contactless card and contactless card functions discussed herein may be utilized in a multi-issuer computing environment. These functions may include tap-to functions where a user may tap their contactless card on a device, such as a mobile device, to perform a function. In some embodiments, the performance of a tap-to-function may charge the power storage device on the contactless card and, in some embodiments, the processor on the contactless card may initiate transmission of sound pulses after completion of the transaction. For example, a user may utilize their contactless card to verify their identity, perform a payment, launch applications, log into applications, autofill a form or field, navigate to a specified web location or app on a device, unlock a door, initiate a contactless card, verify themselves, authenticate the contactless card, and so forth.

The systems discussed here may enable users to perform these functions in a multi-issuer environment. Further, the systems discussed herein enable card issuers or payment providers, such as banks, to issue contactless cards with tap-to functions to clients while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

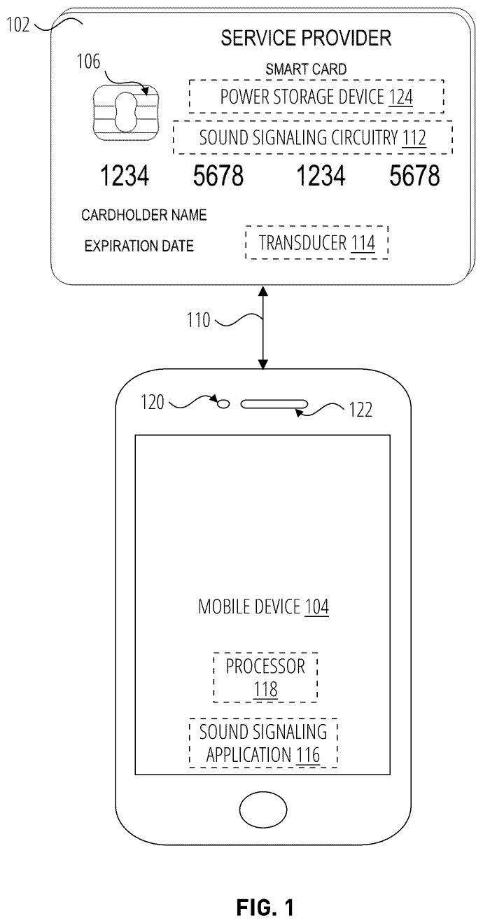

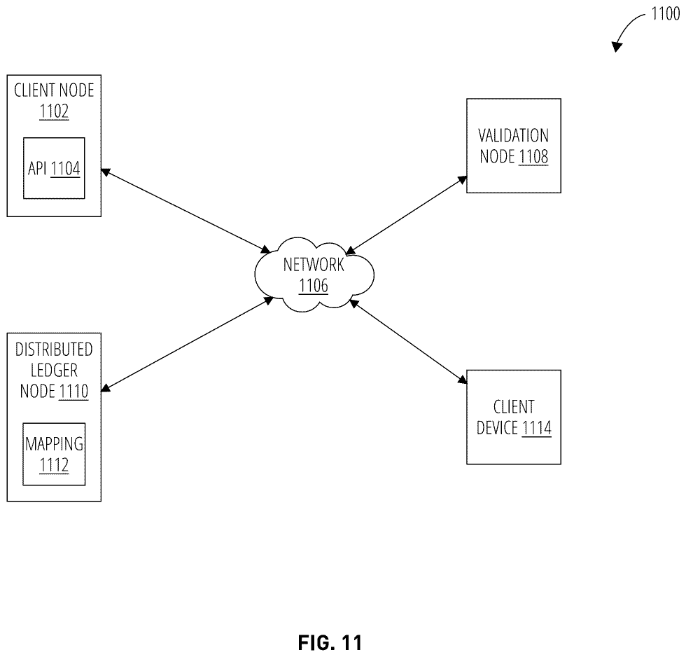

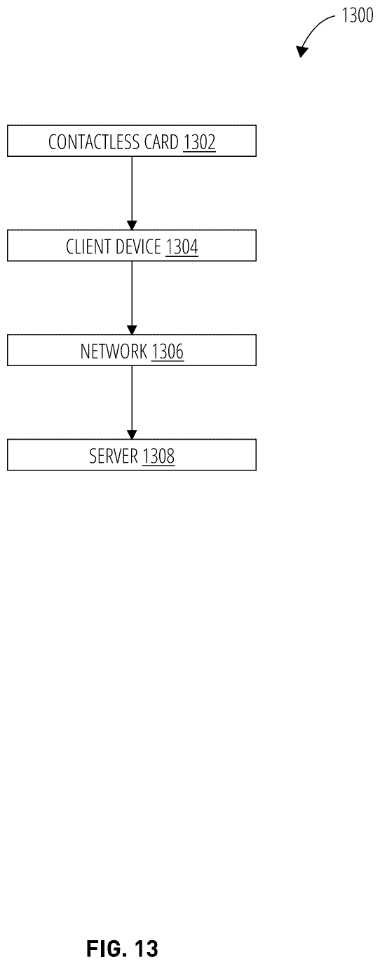

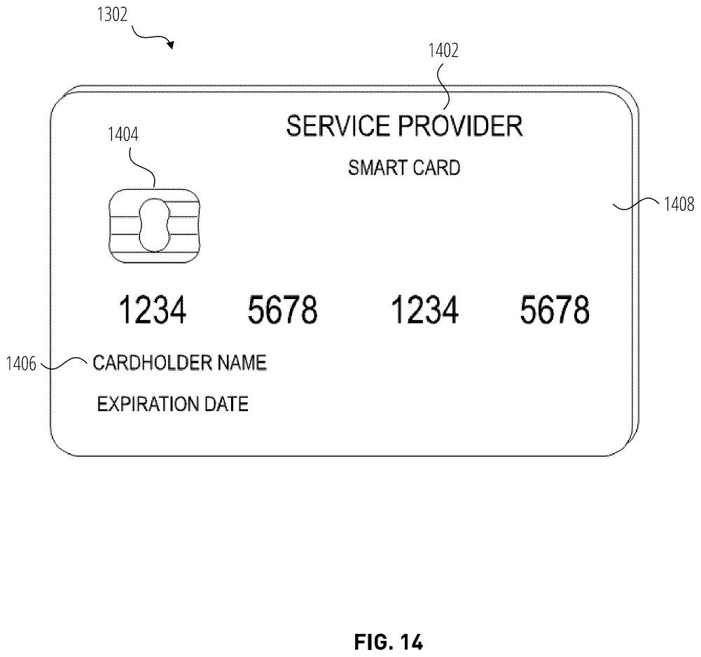

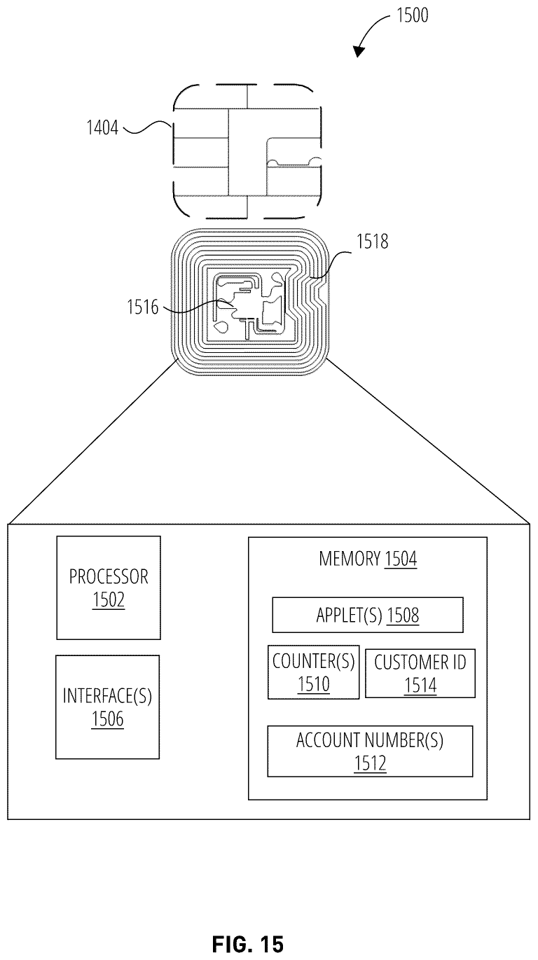

FIG. 1 illustrates an embodiment of a system. The system comprises a chip card 102, such as the contactless card 1302 shown in FIGS. 14-15, and a mobile device 104 such as the client device 1114 shown in FIG. 11 and the client device 1304 shown in FIG. 13. Clients may tend to keep the chip card 102 near the mobile device 104 and want to be notified if the chip card 102 is not within proximity to the mobile device 104 to help the client to avoid misplacing, leaving, or losing the chip card 102 or the mobile device 104. In such situations, the client may have a chip card 102 comprising sound signaling circuitry 112, a power storage device 124, and a transducer 114.

In some embodiments, the sound signaling circuitry 112 be part of a processor executing a sound signaling applet of the chip card 102, may comprise circuitry separate from the processor, may comprise a combination of a sound signaling applet executing on a processor of the chip and the sound signaling circuitry 112.

In many embodiments, the sound signaling circuitry 112 may determine an occurrence of or detect a trigger event and respond to the trigger event by initiating sound pulses. The sound signaling circuitry 112 may apply pulses of power to the transducer 114 to generate the sound pulses. In many embodiments, the sound pulses are inaudible to humans and may be 20 KHz or greater. However, the sound pulses are within the range of frequencies that can be received by the client's mobile device 104. For instance, the client may have provided the chip card 102 at a restaurant for payment of the bill. Processing the payment for the bill with the chip card 102 may involve inserting the contacts 106 in a terminal, which may also charge the power storage device 124. Removing the contacts 106 from the terminal and/or completing the transaction may also trigger the initiation of sound pulses by the sound signaling circuitry 112. As a result, the client may see an alert on the mobile device 104 indicating that sound pulses are being received from the chip card 102. In this situation, the client may advantageously not leave the chip card 102 at the restaurant because, despite other distractions, the sound signaling application 116 may focus the client's attention on retrieving the chip card 102.

As another example, after paying for the items at the store, the client sits the chip card 102 on the counter while packing the items and heads out of the store without the chip card 102. The chip card 102 sound signaling circuitry 112 determines that the power storage device 124 is no longer being charged (communication 110) by the mobile device 104 and initiates sound pulses. The sound signaling circuitry 112 may apply a pulse of power from the power storage device 124 and, in response, the transducer 114 may produce an ultrasonic pulse. The sound signaling application 116 of the mobile device 104 may detect the ultrasonic pulse (or sound wave) via a microphone 120 and produce an audible alert for the client via a speaker 122 of the mobile device 104 to alert the client that the chip card 102 is out of proximity of the mobile device 104. In some embodiments, the sound signaling application 116 of the mobile device 104 may also display a notification on the display of the mobile device 104 stating the chip card 102 is out of proximity of the mobile device 104, or some other statement indication that the client should consider where the chip card 102 is located. Furthermore, the sound signaling application 116 of the mobile device 104 may display or offer a link to display a last known location for the chip card 102 on the display of the mobile device 104. In some embodiments, the map may include a pointer at the current location of the mobile device 102 pointing towards the direction the client is heading and an icon for the chip card 102 on the map, which is located at the last known location for the chip card 102 retrieved from memory of the chip card 102.

Based on the map, the pointer, and the icon for the chip card 102, the client may begin walking towards the last known location. As the client walks closer to the last known location, the sound signaling application 116 of the mobile device 104 may display relative changes in the signal strength of the periodic or intermittent sound pulses. The sound signaling application 116 of the mobile device 104 may also triangulate a current location of the chip card 102, which is at the customer service booth in the store since the store clerk dropped the chip card 102 off at the lost and found location of the customer service booth. For example, the sound signaling application 116 of the mobile device 104 may triangulate the current location of the chip card 102 based on receipt of multiple sound pulses from the chip card 102 as the client was reviewing the alert and walking back towards the last known location of the chip card 102.

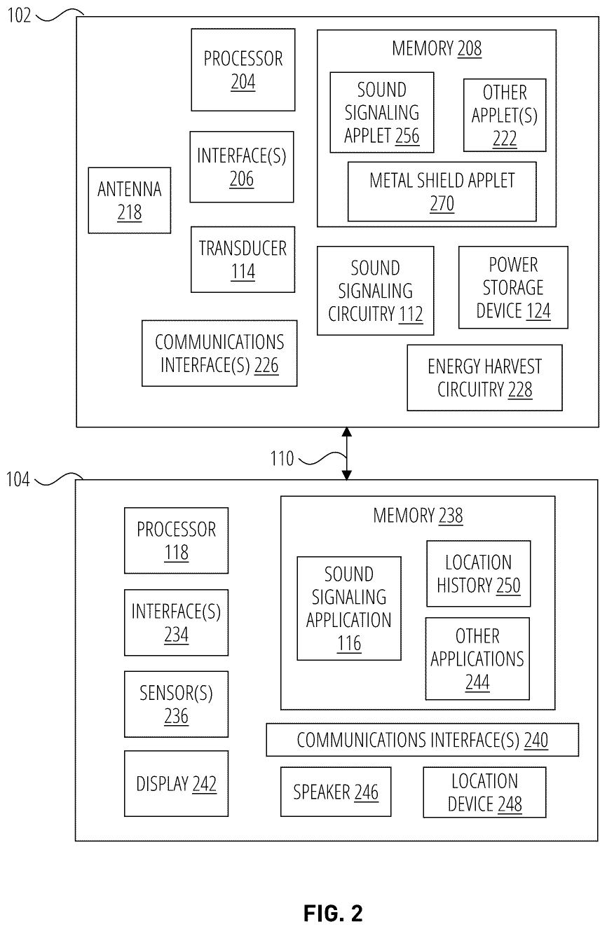

FIG. 2 illustrates another system with the chip card 102 such as the contactless card 1302 shown in FIGS. 14-15, and the mobile device 104 such as the client device 1114 shown in FIG. 11 and the client device 1304 shown in FIG. 13. In this embodiment, the chip card 102 comprises a processor 204, interface(s) 206, a memory 208, the sound signaling circuitry 112, the transducer 114, an antenna 218, the power storage device 124, a communications interface(s) 226, and an energy harvest circuitry 228. The processor 204 may couple with the memory 208 to obtain and execute instructions for the sound signaling applet 256 and one or more other applets 222 in the memory 208. The processor 204 may couple with one or more other devices via one or more of the interface(s) 206 such as the sound signaling circuitry 112, the power storage device 124, the communications interface(s) 226, the energy harvesting circuitry 228, and/or the memory 208. In some embodiments, the interface(s) 206 may comprise direct serial interconnects, one or more buses, driver circuitry, and/or the like.

The memory 208 may comprise volatile and/or non-volatile memory such as random access memory or read only memory, such as flash memory and/or other memory types described herein. The memory 208 may comprise a sound signaling applet 256, a metal shield applet 270, and one or more other applets 222. The sound signaling applet 256 may comprise instructions to execute on the processor 204 for communication 110 with the mobile device 104 to set preferences for the periodicity of sound pulses, trigger events for initiating sound pulses, trigger events to terminate or pause sound pulses, other preferences discussed herein, and/or the like.

The metal shield applet 270 may execute on the processor 204 to detect the presence of a metal shield about the chip card 102 such as an RFID shield of a wallet or purse. The metal shield applet 270 may execute on the processor 204 to cause one or more of the communications interface(s) 226 to generate electromagnetic frequency (EMF) signal and monitor to detect reflections of the EMF signals. Based on a determination that EMF signals received via the antenna 218 and the communications interface(s) 226 are reflections from a metal shield, the metal shield applet 270 may instruct the sound signaling applet 256 or indicate to the sound signaling applet 256 that a trigger event associated with detection of a metal shield occurred. The trigger event associated with detection of a metal shield may cause the sound signaling applet 256 to stop or prevent the sound signaling circuitry 112 from applying power pulses to the transducer 114 to produce sound pulses.

In many embodiments, the processor may communicate 110 with the mobile device 104 via the communications interface(s) s 226 and the antenna 218. For instance, the communications interface(s) 226 may comprise a near field communications interface, a Bluetooth® interface, a WiFi interface, one or more other wireless communications interfaces, and/or the like. For instance, the processor 204 may process payments via the near field communications interface, harvest power from the mobile device 104 via the near field communications interface, perform tap-to-functions such as tap-to-pay via the near field communications interface, communicate 110 with the sound signaling application 116 on the mobile device 104 to set or establish preferences, and/or the like.

In some embodiments, the sound signaling applet 256 executing on the processor 204 may detect a loss of near field communication 110 with the mobile device 104 and monitor for Bluetooth® communications from the mobile device 104. If the sound signaling applet 256 does not detect communications 110 via the communications interface(s) 226 and has not been charging for a predetermined time period, the sound signaling applet 256 executing on the processor 204 may signal or cause the sound signaling circuitry 112 to initiate sound pulses.

The energy harvest circuitry 228 may capture energy from EMF signals such as power transfer signals (oscillating electromagnetic energy) at the near field communication interface of the the communications interface(s) 226 to charge the power storage device 124. For instance, the near field communications interface may receive power via the antenna from a transaction terminal with near field communications or from a near field communications interface of communications interface(s) 240 of the mobile device 104.

The mobile device 104 may comprise a processor 118, interface(s) 234, a sensor(s) 236, a memory 238, communications interface(s) 240, a display 242, a speaker 246, and a location device 248. The processor 118 may execute instructions of a sound signaling application 116 in the memory 238 to monitor one or more of the sensor(s) 236 to detect sound pulses from the chip card 102. In many embodiments, the processor 118 may continuously execute instructions of a sound signaling application 116 to monitor for the sound pulses in the background until a sound pulse is received. After receiving a sound pulse via, e.g., a microphone or a transducer receiver of the sensor(s) 236, the sound signaling application 116 may be brought to a foreground on the mobile device 104 and may present on the display 242, a visual notification to indicate to the client that the chip card 102 is no longer proximate to the mobile device 104. In some embodiments, the mobile device 104 may display a client customizable message that is customizable via preference settings for the sound signaling application 116. In further embodiments, the mobile device 104 may generate an audible alert to indicate that the chip card 102 is no longer proximate to the mobile device 104. In some embodiments, the sound signaling application 116 may display a mute button on the display 242 in conjunction with sounding the audible alert via the speaker 246 to allow the client to mute the audible alert if desired. Furthermore, the audible alert, and visual notification may be customizable by the client via one or more preference settings offered by the the sound signaling application 116.

In some embodiments, the sound signaling application 116 may present a map showing the current location of the mobile device 104 and the last known location of the chip card 102. For instance, the sound signaling application 116 may determine a location of the mobile device 104 each time, or once within every predetermined time period, that the sound signaling application 116 of the mobile device 104 confirms the chip card 102 is proximate to the mobile device 104. In some embodiments, the sound signaling application 116 of the mobile device 104 may charge or maintain the charge level of the power storage device 124 of the chip card 102 at a predetermined charge level to protect the battery or a maximum charge level. To charge the power storage device 124, the sound signaling application 116 of the mobile device 104 may generate an EMF for transferring power to the power storage device 124. Based on communication via a wireless power transfer protocol, the power storage device 124 may indicate the charge level, a target current, a target voltage or the like for the power transfer. Based on the communications during the power transfer, the sound signaling application 116 of the mobile device 104 may determine that the chip card 102 is within a proximity of the mobile device 104 to facilitate power transfer via a near field communications interface of the interface(s) 234.

In some embodiments, if the near field communications interface of the mobile device 104 is unable to communicate with the chip card 102, the sound signaling application 116 of the mobile device 104 may attempt to communicate with the chip card via a Bluetooth® communications interface. If the communication is successful, the sound signaling application 116 of the mobile device 104 may determine that the chip card 102 is proximate to the mobile device 104. If the communication is unsuccessful, the sound signaling application 116 of the mobile device 104 may determine that the chip card is not proximate to the mobile device 104 and alert the client via an audible alert and/or a visual notification. In some embodiments, the mobile device 104 may present, as a visual notification, a map on the display 242 to show the last known location of the chip card 102.

In some embodiments, the sound signaling application 116 of the mobile device 104 may capture a strength of the Bluetooth® communication signal from the chip card 102 and estimate a distance between mobile device 104 and the chip card 102. In such embodiments, if the estimated distance is greater than a threshold distance (which may be a client settable preference), the sound signaling application 116 of the mobile device 104 may alert the client of the estimated distance via a visual notification and/or an audible alert. Note that the audible alert may comprise a simple sound, music, a spoken message (recorded or generated), and/or the like. The visual notification may comprise an indication of the distance of the chip card 102 from the mobile device 104, a message, a graphic display, and/or the like.

After the sound signaling applet 256 of the chip card 102 determines that the mobile device 104 is not proximate to the chip card 102, the sound signaling applet 256 may determine that the a trigger event occurred to cause the sound signaling applet 256 to initiate sound pulses. Thereafter, the mobile device 104 may also detect sound pulses from the chip card 102.

In response to receiving the sound pulses from the chip card 102, the sound signaling application 116 of the mobile device 104 may present a signal strength for the sound pulses on the display 242 of the mobile device 104. The sound signaling application 116 may determine the signal strength based on an intensity of the sound pulse at, e.g., a microphone of the sensor(s) 236.

The visual notification of the signal strength may comprise a calculated value for the signal strength or a graphical representation of the signal strength such as a bar graph, a series of colors that evolve or change toward a first color as the signal strength increases and evolve or change toward a second color if the signal strength decreases, such as changing between blue for cold to red for hot or vice versa. Other visual notifications may include a set of bars that increase in number as the signal strength increases and a decrease in number as the signal strength decreases. Thus, as the client moves closer to the chip card 102, the visual notification may show or illustrate an increase in the signal strength and if the client moves farther from the chip card 102, the visual notification may show or illustrate a decrease in the signal strength.

In some embodiments, the sound signaling application 116 of the mobile device 104 may also present a map showing the current location of the mobile device 104 that updates as the client moves, and shows an indication of the last known location of the chip card 102. In further embodiments, the sound signaling application 116 may perform triangulation calculations/estimations to estimate the current location of the chip card 102 relative the current location of the mobile device 104 based on the signal strengths of the sound pulses at different locations of the mobile device 104.

In some embodiments, the last known location for the chip card 102 may be stored in the location history 250 of the memory 238, the location history 250 may include only the last known location, may include the last known location as well as one or more prior locations of the chip card 102, and, in some embodiments, may include recent estimations of the current location of the chip card 102 via triangulation calculations. Furthermore, the sound signaling application 116 may present one or more or all of the locations in the location history 250 on a map on the display 242 and, in several embodiments, the sound signaling application 116 may include a visual indications to distinguish the older locations from the most recent locations as well as distinguish known locations from estimated locations.

In many embodiments, the mobile device 104 may determine a last known location via a location device 248 such as a global positioning system. In further embodiments, the mobile device 104 may determine locations based on triangulation calculations by the processor 118 from communications with two or more cellular system base stations or access nodes. In still further embodiments, the mobile device 104 may request a current location of the mobile device 104 from a base station or access node of the cellular network.

The other applications 244 may comprise other applications such as an operating system, a phone application, and/or other applications that the client may have on the mobile device 104.

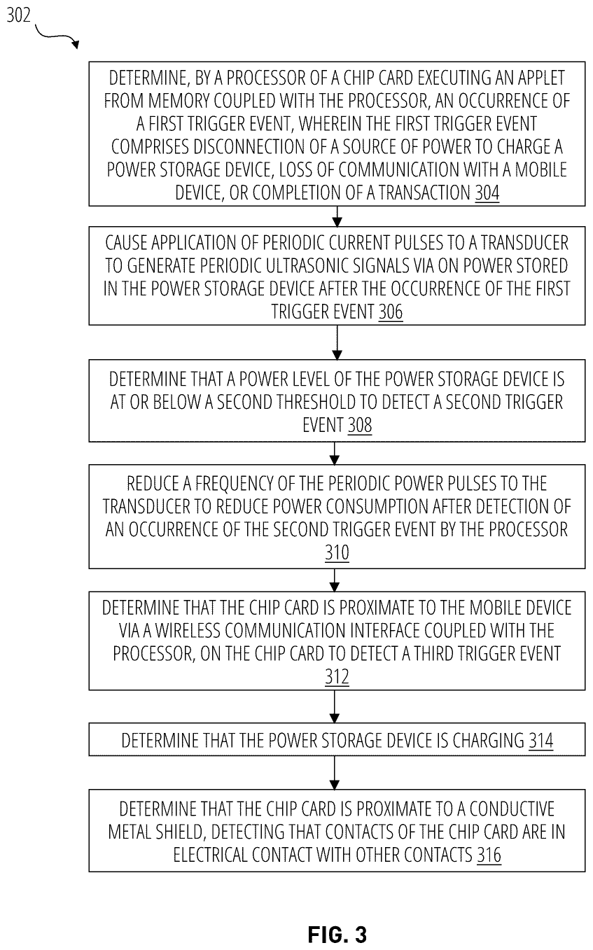

FIG. 3 illustrates an embodiment of a process 302 by a chip card such as the chip card 102 discussed in conjunction with FIGS. 1 and 2. In block 304, the process 302 may determine, by a processor of a chip card executing an applet from memory coupled with the processor, an occurrence of a first trigger event, wherein the first trigger event comprises disconnection of a source of power to charge a power storage device, loss of communication with a mobile device, or completion of a transaction. In block 306, process 302 may cause application of periodic current pulses to a transducer to generate periodic ultrasonic signals via power stored in the power storage device after the occurrence of the first trigger event. For example, the trigger events may be preset for the chip card or may be selectable by a client via an application on a mobile device. The first trigger event may be selected to notify the client as quickly as possible when or after the client might forget to retrieve or misplace the chip card. The ultrasonic signals generated by the chip card may be inaudible to the human ear but may be audible to a microphone or other sensor of the mobile device. The periodic or intermittent ultrasonic signals (sound pulses) may provide the mobile device and, in turn, the client, with a sounding beacon to assist the client to find the chip card.

In block 308, process 302 may determine that a power level of the power storage device is at or below a second threshold to detect a second trigger event. In block 310, process 302 may reduce a frequency of the periodic power pulses to the transducer to reduce power consumption after detection of an occurrence of the second trigger event by the processor. In some embodiments, if enabled, the second trigger event may determine that the level of the power stored in the power storage device is becoming low and, if the client has not yet found the chip card, the sound signaling circuitry of the chip card may reduce the power expenditure for transmission of the ultrasonic signals by reducing the frequency of transmission of the ultrasonic signals.

In block 312, process 302 may determine that the chip card is proximate to the mobile device via a wireless communication interface coupled with the processor on the chip card, to detect a third trigger event. For example, the third trigger event may occur after the client locates the chip card and brings the mobile device in proximity to the chip card. Once the mobile device is in proximity to the chip card, there is no longer a need to cause transmission of the ultrasonic signals to help the client find the chip card. Furthermore, the sound signaling applet of the mobile device may begin to charge the power storage device of the chip card and the chip card may detect the process of transferring power to the chip card. The third trigger event may alternatively involve detection by the sound signaling circuitry of the chip card of the power transfer from the mobile device to the power storage device of the chip card in block 314.

In block 316, process 302 may determine that the chip card is proximate to a conductive metal shield or detect that contacts of the chip card are in electrical contact with other contacts. For instance, if the client places the chip card in an RFID protected wallet, the wallet may contain a metal shield that prevents communication or power transfer between the chip card and the mobile device. Rather than initiating periodic or intermittent ultrasonic signals, the sound signaling circuitry of the chip card may detect the metal shield and determine not to transmit the periodic or intermittent ultrasonic signals. Alternatively, if the chip card is placed in a sleeve or envelope that has contacts to electrically couple with the contacts of the chip card, the sound signaling circuitry of the chip card may determine not to initiate periodic or intermittent ultrasonic signals.

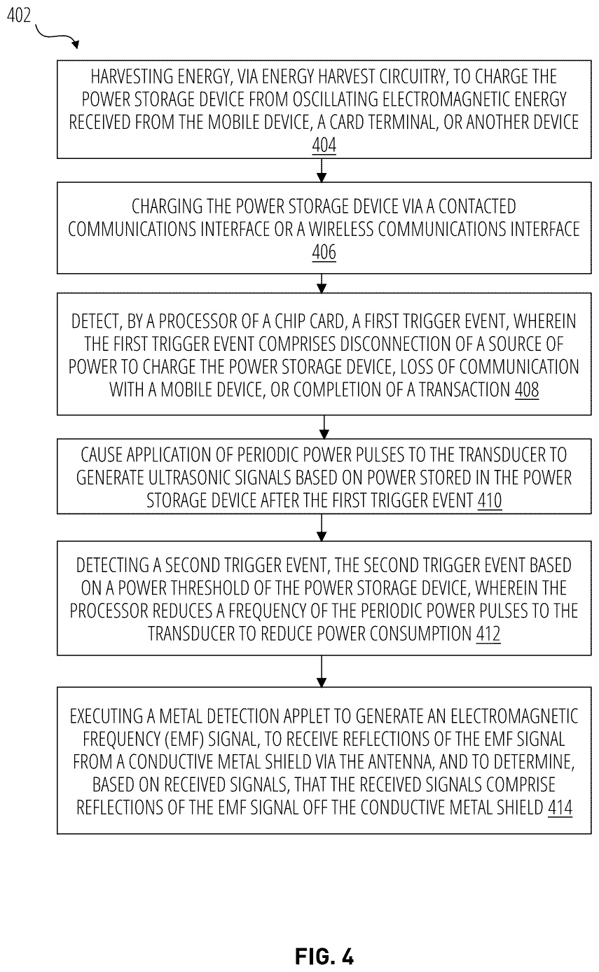

FIG. 4 illustrates an embodiment of a process 402 by a chip card such as the chip card 102 discussed in conjunction with FIGS. 1-3. In block 404, process 402 may harvest energy, via energy harvest circuitry of the chip card, to charge a power storage device of the chip card via oscillating electromagnetic energy received from a mobile device, a card terminal, or another device. For instance, the chip card may comprise energy harvest circuitry to charge the power storage device of the chip card. The power storage device may comprise a thin battery, a capacitor such as a super capacitor, contacts to electrically contact contacts of a terminal such as a payment terminal, and a near field communications interface coupled with an antenna to capture electromagnetic energy provided by a nearfield communications device of a mobile device or another device. The energy harvest circuitry may continuously harvest energy when available to charge or maintain the charge level of the power storage device to assure that the power storage device has power to periodically or intermittently transmit ultrasonic signals upon, in response to, or after detection of a trigger event.

In block 406, process 402 may charge the power storage device via a contacted communications interface of a terminal or a wireless communications interface. For instance, the client may place the contacts of the chip card in a terminal to process a transaction and while the contacts of the chip card are electrically coupled with the contacts of the terminal, the energy harvest circuitry may capture energy such as 3 amperes at 5 volts to charge the power storage device.

In block 408, process 402 may detect, by a processor of a chip card, a first trigger event, wherein the first trigger event comprises disconnection of a source of power to charge a power storage device, loss of communication with a mobile device, or completion of a transaction. For instance, after the transaction via the chip card is complete, the client may remove the chip card from the terminal. After removal of the chip card from the terminal or after the chip card completes a transaction via the terminal, the sound signaling circuitry of the chip card may interpret the event as an occurrence of a first trigger event, which may trigger initiation of ultrasonic pulses.

In block 410, process 402 may cause application of periodic power pulses to a transducer of the chip card to generate ultrasonic signals based on power stored in the power storage device after the first trigger event. For instance, the client may remove the chip card from the terminal prior to leaving the store. If the client does not cause another trigger event that causes the chip card to stop or terminate the process of sending ultrasonic signals, such as brining the chip card in proximity to the mobile device, the sound signaling circuitry of the chip card may send the ultrasonic signals to remind the client to take the chip card or to return to the register at the store to retrieve the chip card. Furthermore, if the client has left the immediate vicinity of the chip card, the mobile device may use the ultrasonic signals to assist the client to find the chip card by presenting the signal strength of the ultrasonic signals on a display of the mobile device.

In block 412, process 402 may detect a second trigger event based on a power threshold of the power storage device. After detection of the second trigger event, the processor of the chip card may reduce the frequency of the periodic or intermittent power pulses to the transducer to reduce power consumption involved with sending the ultrasonic signals. Note that some embodiments may have an intermediate trigger event between the first and the second trigger events that may be based on an expiration of a time period after the initiation of the ultrasonic signaling. The intermediate trigger event may trigger the processor to increase the frequency of applying power pulses to send an ultrasonic signal. In such embodiments, the time period may be predefined and/or a preference that can be modified by the client via a sound signaling application on the mobile device. The time period may be selected to provide a client more ultrasonic signals to assist the client to locate the chip card more quickly. For instance, a default periodicity for the ultrasonic signals may be one ultrasonic signal each 5 minutes. As such, the mobile device may update the signal strength displayed to the client once every 5 minutes. If the reason the client misplaced or left the chip card is that the client inadvertently dropped the chip card on the ground while attempting put the chip card in a pocket, the chip card may be difficult to find. The intermediate trigger may be set to trigger the more frequent pulses for a time frame when the client might be near the chip card but having a difficult time locating the chip card. In such situations, the increased frequency of transmitting the ultrasonic signals may, advantageously, better assist the client in finding the chip card.

In block 414, process 402 may execute a metal detection applet on the processor of the chip card to generate an electromagnetic frequency signal, to receive reflections of the signal from the conductive metal shield via an antenna, and to determine, based on the received signals, that the received signals comprise the reflections of the electromagnetic frequency signal. After determination that the received signals are reflections, the processor may stop or terminate transmission of the ultrasonic signals.

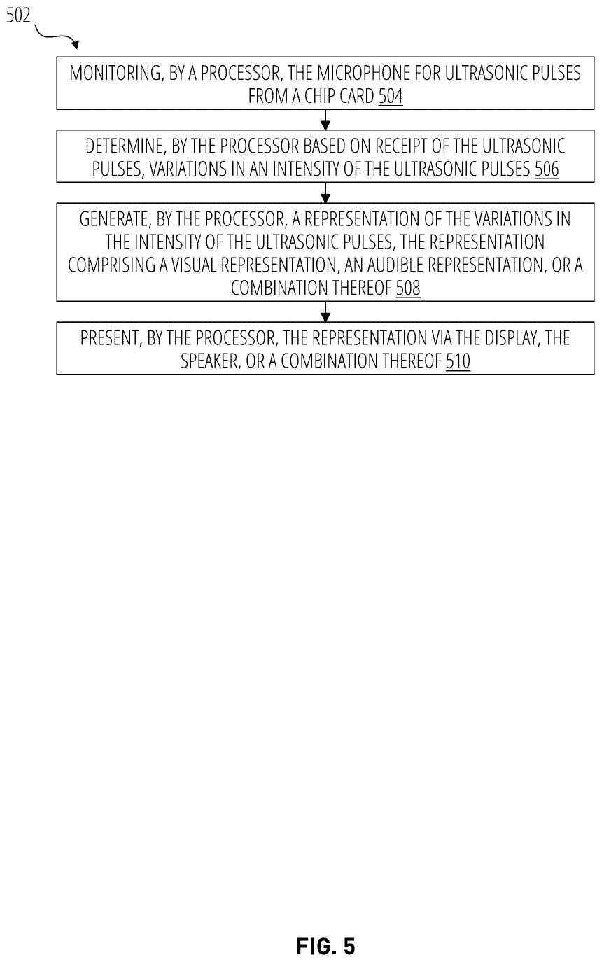

FIG. 5 illustrates an embodiment of a process 402 by a mobile device of a client having a chip card such as the mobile device 104 and the chip card 102 discussed in conjunction with FIGS. 1-4. In block 504, process 502 may monitor, by a processor of the mobile device, a microphone for ultrasonic pulses from the chip card. In block 506, process 502 may determine, by the processor of the mobile device based on receipt of ultrasonic pulses, variations in an intensity of the ultrasonic pulses. For instance, the variations in the intensity of the ultrasonic pulses may result from the client moving toward or away from the chip card.

In block 510, process 502 may generate, by the processor of the mobile device, a representation of the variations in the intensity of the ultrasonic pulses, the representation comprising a visual representation, an audible representation, or a combination thereof. For example, as the client moves closer to the chip card, the pitch, frequency, loudness, and/or the like of the audible representation may increase, indicating to the client that the client is moving closer to the chip card. Similarly, if the client is moving farther away from the chip card, the pitch, frequency, loudness, and/or the like of the audible representation may decrease.

In some embodiments, the visual representation may comprise a visual depiction of an increase in intensity of the ultrasonic signals as the client moves closer to the chip card and a visual depiction of the decrease in intensity of the ultrasonic signals as the client move farther from the chip card. In some embodiments, the intensity depicted may be proportional to the increase or decrease in intensity detected by the sound signal application of the mobile device. In other embodiments, the intensity depicted may be inversely proportional to the increase or decrease in intensity detected by the sound signal application of the mobile device.

In some embodiments, the sound signal application of the mobile device may determine, based on a periodicity of the ultrasonic pulses, that the ultrasonic pulses are generated by the chip card and not just noise or ultrasonic signals generated by another device. In some embodiments, the sound signaling circuitry of the chip card may vary the period between ultrasonic pulses or the bandwidth of the frequency pulses in a manner known to the sound signal application of the mobile device so the sound signal application of the mobile device may determine that the ultrasonic signals are generated by the client's chip card and not a different chip card.

In some embodiments, the sound signal application of the mobile device may, after detecting the presence of the chip card in proximity to the mobile device, determine a location of the mobile device, and store the location of the mobile device in memory as the last known location of the chip card. In some embodiments, the sound signal application of the mobile device may detect an absence of the chip card within a proximity about the mobile device via a communications interface of the mobile device such as a near field communications interface, a Bluetooth® interface, or another wireless communications interface. In such embodiments, the sound signaling application executing on a processor of the mobile device may notify the client of the absence via audible and/or visual notifications such as via an audible tone via a speaker or a visual notification on the display of the mobile device.

In some embodiments, the sound signal application of the mobile device may generate a visual alert comprising an indication of a location on a map to present a geographical location of the last known location of the chip card to the client. In some embodiments, the sound signal application of the mobile device may generate a pointer on the display of the mobile device to indicate a direction of the last known location relative to a current location of the mobile device.

In some embodiments, the sound signal application of the mobile device may triangulate a location of the chip card relative to the mobile device based on receipt of ultrasonic pulses from the chip card and may present a pointer on the display indicative of the location of the chip card relative to a current location of the mobile device. In some embodiments, the sound signal application of the mobile device may generate an oscillating electromagnetic field to charge a power storage device of the chip card while the chip card is proximate to the mobile device.

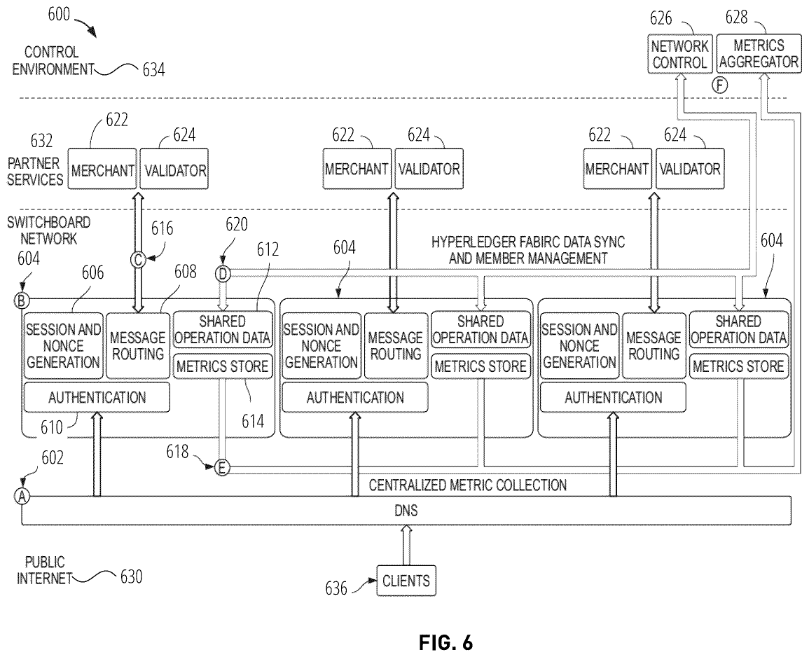

FIG. 6 illustrates an example of system 600 in accordance with the embodiments discussed herein. The system 600 includes additional devices and systems configured to enable contactless card issuers to tap-to-card services. Specifically, system 600 enables any number of issuer systems to provide card services to their clients through a switching fabric, i.e., the switchboard system in a secure and safe manner.

In embodiments, the switchboard system includes one or more nodes 604 configured to perform routing operations. Each switchboard node 604 may include a session and nonce generator 606, a message router 608, an authentication 610, an operation data 612 store, and a metrics store 614. Further, each of the nodes may be configured the same and share configurations, but each switchboard node 604 may independently process and route messages and requests to the appropriate systems, such as the merchant systems and issuer systems. Each of the nodes 604 is configured to act as a broker of trust between an issuer system, the merchant system 622, and/or validation system 624, for example. Each switchboard node 604 is configured to route each message to the correct issuer system while maintaining data security. For example, a switchboard node 604 may route a message between an issuer system and a merchant system while the node cannot access the private data in the message.

The switchboard system 600 may be configured as a server system with a collection of hardware, software, and networking components that work together to provide client services. Hardware components may include one or more server computers, storage devices, and network adapters. The server computers are configured to run server applications, such as those executable on each of the nodes 604. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

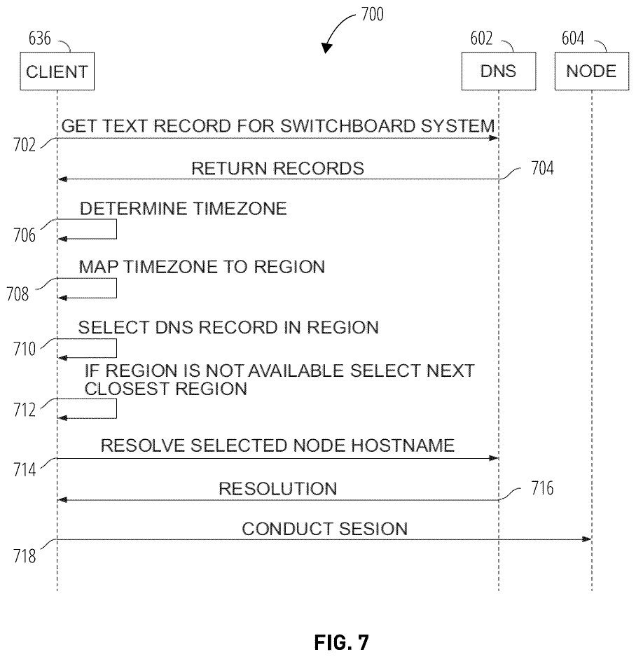

In some embodiments, the nodes 604 may operate in a cloud-based computing environment, e.g., a collection of hardware, software, and networking components that enable the delivery of cloud computing services. The switchboard nodes 604 and the computing services are delivered over the Internet and can be accessed from anywhere in the world with an Internet connection. In embodiments, client 636 may access a switchboard node 604 through DNS 602 or Domain Name System (DNS). The DNS 602 is a hierarchical and distributed naming system for computers, services, and other resources connected to the Internet or other networks. It associates various information with domain names assigned to each registered participant. In one example, the DNS 602 may translate a name known to software executing on a client 636 to route data to one or more of switchboard node 604 of the switchboard system. In embodiments, the DNS 602 may generate a number, such as an Internet Protocol (IP) address, an address record (A-record), or another Hostname (C-name record). FIG. 7 illustrates one example sequence 700 for a client to identify and resolve an identifier for one of the nodes 604 of the switchboard system. At a high level, the DNS 602 translates known domain names to numerical Internet Protocol (IP) addresses needed for locating and identifying computer services and devices with the underlying network protocols. Clients use the global DNS system to select the best node to use, as discussed in sequence 700.

In embodiments, a client 636 communicates with the switchboard system to perform one or more of the partner services 632, such as conducting a transaction with a merchant, validating the customer, or other tap-to functions. Once client 636 identifies a switchboard node 604 and resolves an address to communicate with switchboard node 604, client 636 may send one or more messages to switchboard node 604 to authenticate and perform the operation. The switchboard node 604 includes an authentication 610 function that is configured to authenticate the client 636. In embodiments, the client 636 sends a message or authorization request to the switchboard node 604 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 604 may authorize or authenticate the client 636 or user, and the switchboard node 604 may utilize the additional components, such as the session and nonce session and node generator 606 and message router 608, to perform the operations. Note the validation systems validation system 624 never interact with the merchant systems 622, nor vice versa. The nodes node 604 brokers all communication.

In embodiments, the switchboard system may utilize a hyper ledger fabric 620 to manage to synchronize the shared operation data 612 and member management across the network. The hyperledger fabric 620 is distributed ledger framework having a permissioned network model that only authorized participants can join the network and access the data that is stored on a ledger.

In embodiments, the hyperledger fabric 620 may be generated by creating one or more sets of peers, an ordering service, and a channel. Once the network is created, system 600 deploys chaincode to the network, or node 604 is permitted to access the fabric. The chaincode is the code that runs on the blockchain and executes the network control 626 and operation data 612 logic code. Once the chaincode is deployed, each of the switchboard nodes 604 is configured to invoke transactions on the blockchain to add data to the blockchain, e.g., the operational data. A switchboard node 604 or another device can query the ledger to retrieve data. The ledger is a distributed database that stores all the data added to the blockchain.

All nodes 604 keep an independently verifiable log of their actions that can be transmitted to a centralized aggregator to build a picture of overall network usage. System 600 can manage network operation data and management at a central level and have a centralized view of network use, aggregated and abstracted to the appropriate level.

FIG. 7 illustrates an example sequence 700 for a client to utilize DNS to resolve and communicate with one or more nodes of a switchboard system. The illustrated sequence 700 includes a client 636, a DNS 602, and a switchboard node 604. At 702, the sequence 702 includes the client 636 sending a request to a default DNS server for a text record switchboard.{domain}. {tld}. The text record may be preconfigured in a client app and/or client SDK. At 704, the DNS 602 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 604

In embodiments, the client 636 may determine the current timezone at 706. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 708, the client 636 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_{——}York | North America/East | na-e |
| America/Buenos_{——}Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e <-> na-w and sa <-> na-w and sa <-> na-e. This representation is useful for node selection.

At 710, the client 636 may identify or select a DNS record option returned at 704 that is in the region. If there are multiple matches, the client 636 may select one at random. If there's no node available in a region, the client 636 may determine and use a data graph of neighboring regions to select a node in the closest region where a node is available at 712. For example, sa has no node but is connected to na-e where there is a node and so na-e is selected. In some embodiments,

At 714, the client may resolve a selected node's hostname. In embodiments, the client 636 may automatically resolve the hostname using the client's HTTP request default resolver. At 716, the DNS 602 may return a result. And at 718, the client 636 may communicate with a switchboard node 604 and begin the process to interact with the switchboard.

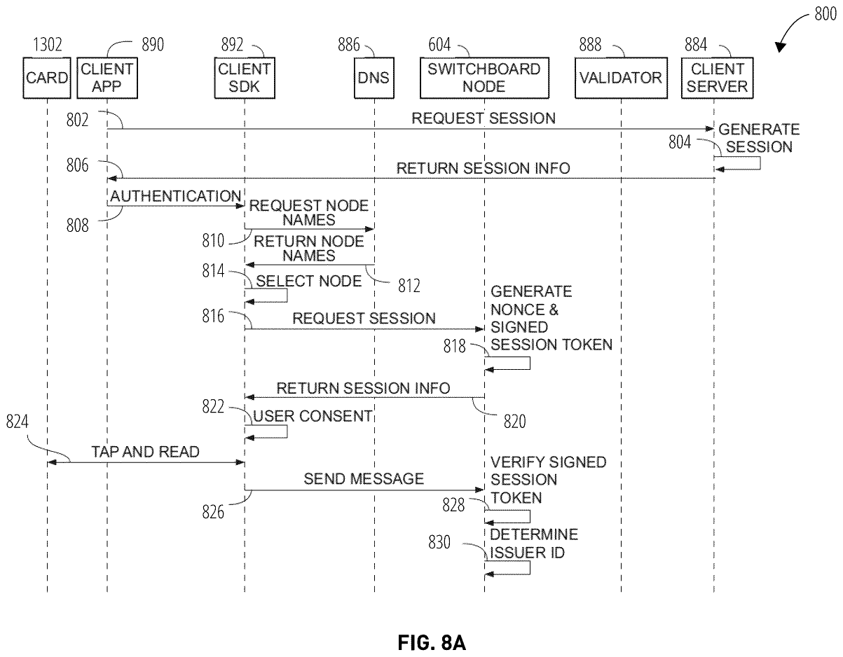

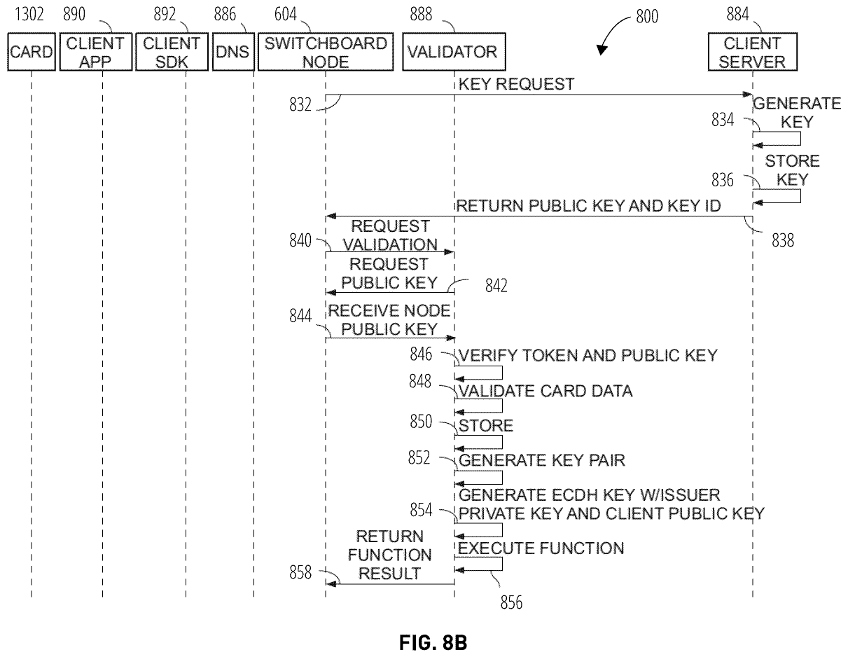

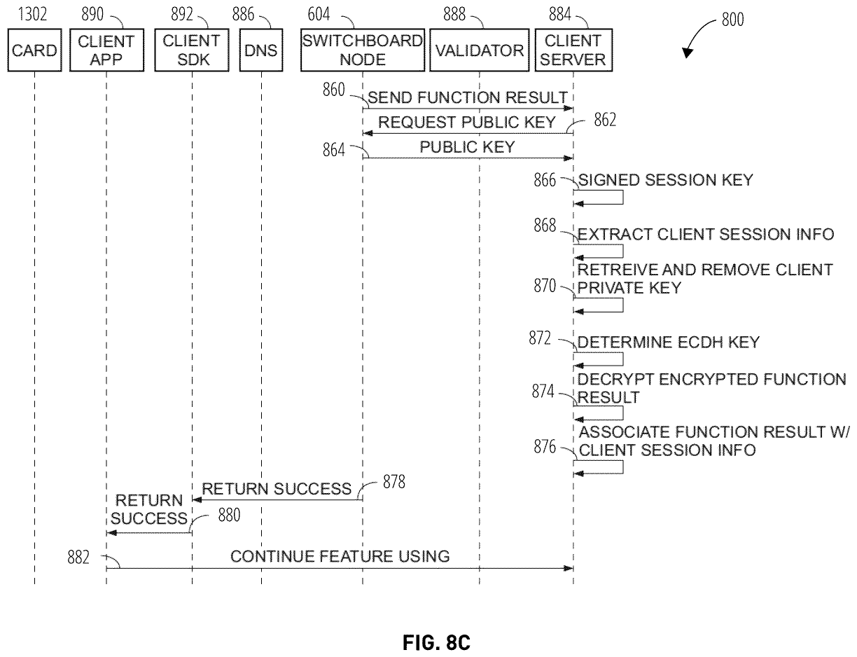

FIG. 8A-FIG. 8C illustrate an example sequence 800 to perform operations between a contactless card and services provided by a card issuer and/or merchant. The illustrated sequence 800 includes actions and communications performed by a contactless card 1302, a client 636 including a client app 890 and a client SDK 892, a DNS 886, a switchboard system including one or more nodes 604, a partner services 632 including a merchant and/or validator 888, and control services 634 including a client server 884 or system. In embodiments, the client app 890 may be any application configured to execute on a client 636, such as a banking app, a merchant app, a social media app, a travel app, a gaming app, a productivity app, an entertainment app, and so forth. In embodiments, the client app 890 includes a web browser to provide websites and pages. The client app 890 may include and/or utilize the client SDK 892, which may be a set of instructions that enable the client app 890 to communicate with other components of the switchboard system.

In embodiments, as shown in FIG. 8A, at 802 the client 636 including the client app may send a request and establish a session with a client server 884 such that a result may be associated with the correct client device or user. The request establishes a relationship between the client device and client server, which may be an issuer server. At 804, the client server 884 generates a session and CLIENT SESSION INFORMATION. At 806, the client server 884 returns the session information, e.g., the CLIENT SESSION INFORMATION. In embodiments, the CLIENT SESSION INFORMATION may be the Client implementation-specific user session identification information.

At 808, the client 636 may initiate a contactless card authentication process with the client 636. For example, the client 636 may call a function and/or pass information to the client 636 to initiate authentication via a contactless card 1302. At 810-814, the client 636 may utilize DNS to identify a node and establish communication with the node. Specifically, at 810, the client 636 including the client SDK 892 may send a request for switchboard hostnames, and at 812 the the DNS 886 may return information including one or more hostnames. At 814, the client 636 may determine a switchboard node to communicate. FIG. 7 illustrates an example of a more detailed sequence of the process to establish communication with a switchboard node 604.

At 816, the client 636 may send a request for a session to the switchboard system 600. In embodiments, the request for a session may be for a function request in the format <FUNCTION REQUEST>. In embodiments, the FUNCTION REQUEST may be the data/function that the client 636 would like to request once a contactless card 1302 has been validated. The function could be for any service discussed herein, e.g., authenticate the user, perform a transaction, request autofill data, etc. At 818, switchboard system 600 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 1302. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 600 private key. The switchboard system 600 may include a NODE PUBLIC/PRIVATE KEY, which is a keypair used to sign and validate JWTs.

At 820, the switchboard system 600 may return session information to the client 636. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 822, the client SDK 892 may determine and/or receive user consent to the terms of service. In one example, the client SDK 892 captures and records the user consent to <FUNCTION TOS> on <CONSENT DATE> with <TOS VERSION>. The CONSENT DATE may be the timestamp for the user's consent to the TOS.

At 824, the client 636 exchanges one or more messages with a contactless card. In one example, the exchange may be based on the contactless card being tapped to a client device. In embodiments, the client SDK 892 may provide data to the contactless card 1302 to use during the session to perform the function. The data may be provided to the contactless card 1302 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes |
| 0E | | binary data |
| 0F . . . | Session | 4 bytes of ASCII HEX encoded 2 bytes |
| 12 | Indicators | binary data |
| 13 . . . | Control | 4 bytes of ASCII HEX encoded 2 bytes |
| 16 | Indicators | binary data |
| 17 . . . | Update Date | 16 bytes of ASCII HEX encoded 8 bytes |
| 26 | creation Time | binary data - represents 64 bit unix |
| | | timestamp |
| 27 . . . | Update MAC | MAC to protect control indicators - 16 bytes |
| 36 | | of ASCII HEX encoded 8 bytes binary data |

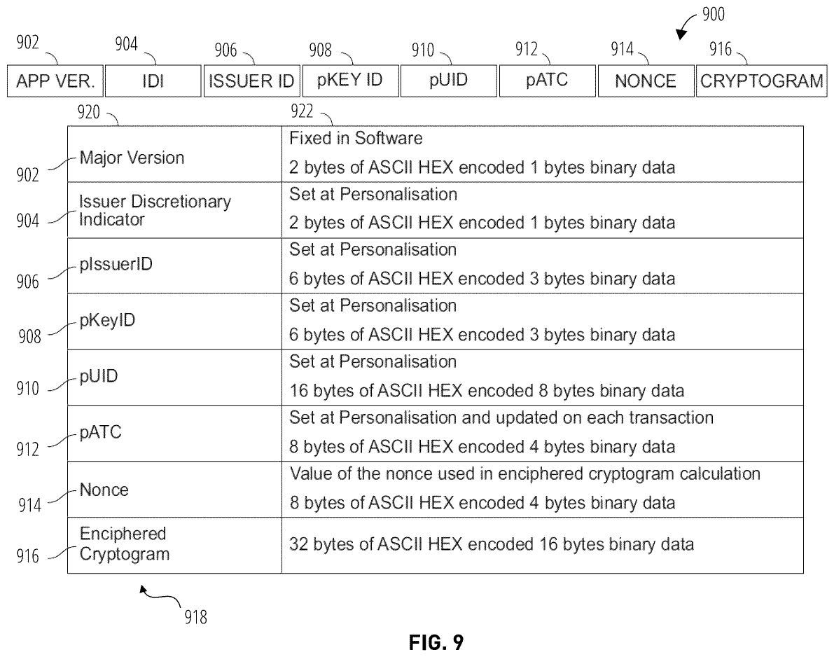

The updated MAC may be calculated to protect the control indicators in embodiments. Specifically, The MAC M is determined by calculating a MAC over the 10 bytes of the update data U with the Update MAC Card Key (MCK), as described in FIG. 9, message 900.

At 824, the contactless card may generate and provide a message to the client's device including the client SDK 892. The data in the message may be utilized by the system discussed herein to perform the function requested. One example of the message is illustrated and discussed in FIG. 9, message 900.

At 826, the client including the client SDK 892 may send a message and information to the switchboard system 600. The message may be the message received from the contactless card 1302, e.g., message 900. In addition, the client SDK 892 may send the consent date, the TOS version, and the signed session token to the switchboard system 600. The switchboard system 600 may utilize the information to ensure the session is valid. At 828, the switchboard system 600 verifies the signed session token is valid, e.g., is the previously provided signed session token and includes the nonce previously generated and is in the message.

In some embodiments, the switchboard system 600 is configured to determine which issuer system or client-server it should route the message to for processing. At 830, the switchboard system 600 may determine the issuer ID by extracting it from the message received from the contactless card 1302 via the client SDK 892. As mentioned, the issuer ID identifies the issuer of the contactless card 1302.

FIG. 8B continues the sequence 800 from FIG. 8A. In embodiments, the switchboard system 600 is configured to generate and communicate secure communications with the issuer system, e.g., the client server 884 and the validator 888. At 832, the switchboard system 600 sends a request for a key to the client server 884. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 834, the client server 884 generates a portion of the key. In some instances, the client server 884 may generate half of the ECDH key for encryption/decryption of PII. Specifically, the client server 884 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 836, the client-server 884 stores the generated portion of the key in storage. Specifically, the client server 884 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 884 may return the public key portion to the switchboard system 600 with the KEY ID at 838. The switchboard system 600 may store the public key portion with the KEY ID for later use, e.g., generation of the ECDH key. At 840, the switchboard system 600 may request a validation to be performed by the validator 888. In one example, the switchboard system 600 may send a request validation as Request validation <MESSAGE>, <SIGNED SESSION TOKEN>, <CLIENT EC PUBLIC KEY>, <CONSENT DATE>, and the <TOS VERSION>. The validator 888 may make an out-of-band request back to the switchboard system 600 for the public key to verify the session at 842. At 844, the switchboard system 600 may provide the node's public key, i.e., <NODE PUBLIC KEY>. Further at 846, the validator 888 may utilize the node's public key to verify the secure session token.

In embodiments, the validator 888 may validate the message at 848. In embodiments, the validator 888 may perform a number of validations including ensuring the nonce in the message is correct along with additional information, such as the card's unique identifier (pUID), and the counter value (pATC).

At 850, the validator 888 may store information associated with the session. For example, validator 888 may store the <CONSENT DATE> with the <TOS VERSION> and the <PUID>. The validator 888 may also generate another portion of the key, e.g., the ECDH key. For example, the 888 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 854, the validator 888 may generate the complete ECDH key. For example, the validator 888 generates the <ECDH KEY> from <ISSUER EC PRIVATE KEY> and <CLIENT EC PUBLIC KEY>. The ECDH KEY is the final key generated using ECDH key negotiation.

The validator 888 may utilize the ECDH KEY to encrypt data for the function. For example, if the validator 888 validates the message in some instances, the validator 888 may execute a function request to create a function result and encrypt the result with the ECDH KEY at 856. For example, the validator 888 may Execute <FUNCTION REQUEST> to create <FUNCTION RESULT> and encrypt it with the <ECDH KEY>. The function result may be any result based on the requested function, e.g., verification of the card.

At 858, the validator 888 may return the function result to the switchboard system 600. In some instances, the function result is returned encrypted. For example, the validator 888 may return the <ENCRYPTED FUNCTION RESULT> and the <ISSUER EC PUBLIC KEY>.

FIG. 8C continues the sequence 800 from FIG. 8B. In embodiments, at 860 the switchboard system 600 sends the function result to the client server 884 to process the result. In one example, the switchboard system 600 may send the <ENCRYPTED FUNCTION RESULT>, <KEY ID>, <ISSUER EC PUBLIC KEY>, and <SIGNED SESSION TOKEN>. At 862 and 864, the client server 884 may make a request for and receive the public key from the switchboard system 600. In some instances, the exchange may be performed via out-of-band communication channels. The public key for the node may be <NODE PUBLIC KEY>. The public key may be used to verify the sender of the function result, etc. At 866, the client server 884 may verify the signed session key with the node's public key <NODE PUBLIC KEY> to verify the sender of the information. At 868, the client server 884 may extract client information from the signed session token. For example, the client server 884 may Extract <CLIENT SESSION INFO> from <SIGNED SESSION TOKEN>, i.e., extracting the client implementation-specific user session identification information.

Further, at 870, the client server 884 may retrieve the client's private key with the KEY ID. Specifically, the client server 884 may get and remove the <CLIENT PRIVATE KEY> from cache using the <KEY ID>. At 872, the client server 884 may generate or compute the ECDH key. For example, the client server 884 may compute the <ECDH KEY> with the <CLIENT PRIVATE KEY>+<ISSUER EC PUBLIC KEY>. The client server 884 may decrypt the function result with the computed key at 874. Specifically, the client server 884 may decrypt the <ENCRYPTED FUNCTION RESULT> with the <ECDH KEY> to determine the <FUNCTION RESULT>. At 876, the client server 884 associates the function result with the session.

In embodiments, the switchboard system 608 may return whether the function result was successfully completed or not at 878 to the client SDK 892. Further at 880, the client SDK 892 may notify the client app 890 of the result. At 882, the client app 890 may utilize the feature. For example, the 882 may communicate with the client server 884 to continue the feature using the <CLIENT SESSION INFO> to fetch the redacted <FUNCTION RESULT>.

FIG. 9 illustrates an example of a message 900 that may be communicated by a contactless card to perform the functions described herein, such as those discussed in FIG. 8A through FIG. 8C. One or more of the fields in message 900 may also be utilized to route the message 900 through the switchboard system and perform authentication/validation techniques.

In embodiments, the message 900 includes an applet version 902 field, an issuer discretionary indicator 904 field, an Issuer Identifier 906 field, a pKey ID 908 field, a pUID 910 field, a pATC 912 field, a nonce 914 field, and an encrypted cryptogram 916.

In embodiments, the fields may be in plain text or encrypted. For example, the applet version 902 field may include an applet version in plain text. The applet version indicates which applet version is installed on a contactless card and may be used by the other systems to determine how to process the message 900 when communicated. For example, different Applet versions require different validation logic, e.g., an older message may be routed through the issuer system to perform various operations for validation, while a newer message may be routed through the switchboard system to perform the various operations, including validation.

In embodiments, the message 900 includes an issuer discretionary indicator 904 field that may include issuer data and set at the time of personalization. In addition, the message 900 includes an Issuer Identifier 906 field that may include a unique ID assigned to the entity issuing the card, e.g., the issuer. For example, when joining the system, each issuer may be assigned a unique identifier during an onboarding operation. The issuer ID can be used by the switchboard system 608 to route a message and its contents to the appropriate services that are associated with that particular issuer.

In embodiments, the message 900 includes a pKey ID 908 field. In some instances, the pKey ID 908 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 1302 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs.

The message 900 may include a pUID 910 field, including a card unique identifier assigned to the contactless card at personalization time. The pUID 910 field data may be a combination of alphanumeric characters used to identify each card and associated with a user uniquely.

In embodiments, the message 900 includes a pATC 912 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 900 is created, a new session key is derived and utilized to generate one or more portions of the message 900. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 900 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 1302 may communicate a message between a device, such as a mobile device, during a read operation. For example, in response to the contactless card 1302 being tapped onto a surface of the device, e.g., brought within wireless communication range, a read operation may be performed on the contactless card 1302, and the contactless card 1302 may generate and provide the message to the device. For example, once within range, the contactless card 1302 and the device may perform one or more exchanges for the contactless card 1302 to send the message to the device.

The wireless communication may be in accordance with a wireless protocol, such as near-field communication (NFC), Bluetooth, WiFi, and the like. In some instances, a message may be communicated between a contactless card 1302 and a device via wired means, e.g., via the contact pad, and in accordance with the EMV protocol.

As discussed above, the contactless card 1302 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 1302. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 1302 stores the generated application key(s) or UDK(s).

In embodiments, the contactless card 1302 utilizes the application key(s) or UDK(s) to generate session keys for each encrypted data is generated. The following is one processing flow that may be performed by the contactless to generate a unique cryptogram session key (ASK).

To generate the ASK, the contactless card 1302 computes SKL by encrypting [ATC[2]∥ATC[3]∥‘F0’∥‘00’∥[ATC[0]∥[ATC[1]∥[ATC[2]∥[ATC[3] with an application key. Further, the contactless card 1302 computes SKR by encrypting [ATC[2]∥ATC[3]∥‘0F’∥‘00’ ∥[ATC[0]∥[ATC[1]∥[ATC[2]∥[ATC[3]] with the application key. Finally, the contactless card 1302 concatenates SKL with SKR to form an authentication session key (ASK). In embodiments, the ASK is used to perform operations utilizing the contactless card 1302, such as encrypting the cryptographic MAC.

In embodiments, the contactless card 1302 also supports session key derivation to generate a unique encipherment session key DESK. The contactless card 1302 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 1302 computes SKR by encrypting [ATC[2]∥ATC[3]∥‘0F’∥‘00’∥‘00∥‘00’∥‘00’∥‘00’] with the DEK or UDK. The contactless card 1302 concatenates SKL with SKR to form the Data Encipherment Session Key (DESK).

In embodiments, the contactless card 1302 generates encrypted data or a cryptogram utilizing the session keys. Specifically, the contactless card 1302 generates a cryptogram C by calculating a MAC over the 32-byte transaction data T using the Authentication Session Key (ASK).

The contactless card 1302 may process the data to generate the cryptogram. Specifically, the contactless card 1302 divides T into four blocks of 8 bytes of data: T=T1∥T2∥T3∥T4. The contactless card 1302 computes B=DES(ASKL) [T1], where is the Data Encryption Standard or another symmetric encryption algorithm, ASKL is a portion of the ASK, e.g., the “left” half of the key. The contactless card 1302 computes B=[B XOR T2], and, the contactless card 1302 computes B=DES(ASKL) [B], where DES is an encryption algorithm. The contactless card 1302 computes B=[B XOR T3], and the contactless card 1302 computes B=DES(ASKL) [B]. The contactless card 1302 computes B=[B XOR T4], and the contactless card 1302 computes B=DES(ASKL) [B]. The contactless card 1302 computes B=DES⁻¹ (ASKR) [B], where DES⁻¹ is the reciprocal DES operation, and ASKR is a portion of the ASK, e.g., the right half. The contactless card 1302 computes the cryptogram C=DES(ASKL) [B].

In embodiments, a contactless card 1302 may also encipher the cryptogram to secure the data further. For example, a contactless card 1302 may generate an 8-byte random number [RND] and the card computes E1=DES3(DESK) [RND], where DES3 is a symmetric encryption algorithm such as the Triple Data Encryption Standard. The contactless card 1302 then computes B=[E1] XOR [C], where C is the cryptogram generated, as discussed above. The contactless card 1302 computes E2=DES3(DESK) [B], where B is computed above. Further, the contactless card 1302 generates the 16-byte enciphered payload E=[E1] ∥[E2].

In embodiments, a device or the contactless card 1302 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 1302 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

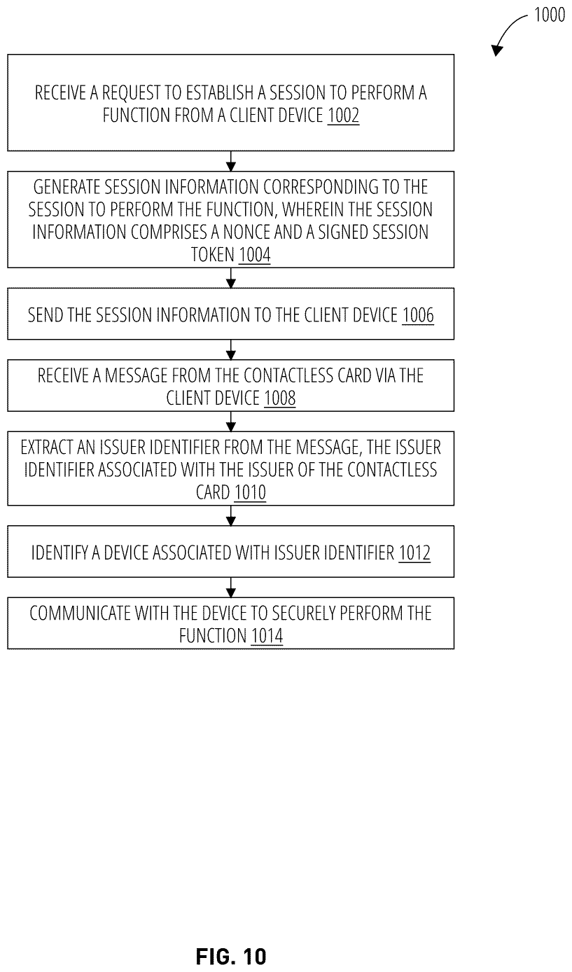

FIG. 10 illustrates an example of method 1000 in accordance with embodiments discussed herein. In block 1002, the method 1000 includes receiving, by a node in a system, a request to establish a session to perform a function from a client device, wherein the function is at least partially performed utilizing a contactless card, such as contactless card 1302. In some instances, the node may be one of a plurality nodes of a switchboard system. The node may be previously selected by the sending device via a DNS operation performed.

In block 1004, the method 1000 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1006, method 1000 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 9).

In block 1008, method 1000 includes receiving, by the node, a message from the contactless card via the client device. The message may be generated by the contactless card. FIG. 9 illustrates one example of a message 900. In some embodiments, the node verifies the message. For example, the node may verify a nonce in the message and a signed session token.

In block 1010, method 1000 extracts an issuer identifier from the message by the node, the issuer identifier associated with the issuer of the contactless card. In some instances, the issuer identifier may be in a plaintext format.

In block 1012, method 1000 identifies, by the node, a device associated with the issuer identifier. For example, the node may perform a lookup to determine a server associated with the issuer identifier and the function to be performed.

In block 1014, method 1000 communicates, by the node, with the device to securely perform the function.

FIG. 11 illustrates a distributed network authentication system 1100 according to an example embodiment. As further discussed below, system 1100 can include client node 1102, API 1104, network 1106, distributed ledger node 1110, mapping 1112, and client device 1114. Although FIG. 11 illustrates single instances of the components, system 1100 can include any number of components.

System 1100 can include a client node 1102, which can be a network-enabled computer as described herein. In some examples, client node 1102 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 1102 can execute one or more applications, such as software applications, that enable, for example, network communications with one or more components of system 1100, transmit and/or receive data, and perform the functions and processes described herein.

The client node can contain an API 1104. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1104 to interact with the service, such as by performing a remote call to an API for interacting with a web-based service.

API 1104 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1102 can communicate with one or more other components of system 1100 either directly or via network 1106. Network 1106 can comprise one or more of a wireless network, a wired network or any combination of wireless network and wired network, and may be configured to connect the components of system 1100. While FIG. 11 illustrates communication between the components of system 1100 through network 1106, it is understood that any component of system 1100 can communicate directly with another component of system 1100, e.g., without involving network 1106.

System 1100 can include a validation node 1108, which can be a network-enabled computer as described herein. In some examples, validation node 1108 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 1108 can execute one or more applications, such as software applications, that enable, for example, network communications with one or more components of system 1100, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 1110, which can be a network-enabled computer as described herein. In some examples, distributed ledger node 1110 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 1110 can execute one or more applications, such as software applications, that enable, for example, network communications with one or more components of system 1100, transmit and/or receive data, and perform the functions and processes described herein.

Distributed ledger node 1110 can containing a mapping 1112. In some examples, mapping 1112 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 1110, and in other examples the one or more databases can be stored outside of distributed edger node 1110 but in data communication with distributed ledger node 1110. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1110. In other examples, the one or more databases can be remote from distributed ledger node 1110 but in data communication with distributed ledger node 1110. Data communication between the one or more databases and distributed ledger node 1110 can be a direct data communication or data communication via a network, such as the network 1106.

In some examples, client node 1102 can be in data communication with distributed ledger node 1110. Distributed ledger node 1110 can contain mapping 1112. Mapping 1114 may include, e.g., a mapping between a validation node address and the validation node 1108, a mapping between a routing number and a validation node address, and/or a mapping between a routing number and validation node 1108. In some examples, mapping 1112 can include a digital signature associated with an entity having permission to validate for a routing number. Based on one or more of these associations, client node 1102 can call validation node for validation and/or provide direction to the client device to reach the appropriate validation node. This can be accomplished by calling a validation API associated with validation node 1108.

In some examples, iterations of the mappings described herein, such as mapping 1112, can also include a software or applet version number. The version number can be used to identify a validation node or validation node address or choose between multiple validation addresses for one validation node.

In some examples, client node 1102 and distributed ledger node 1110 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1110 can update mapping 1112 to reflect a different association between, e.g., a routing number, a validation node address, and a validation node. In some examples, degrees of permissions can be issued. For example, if client node 1102 were to function to route data to validation node 1108 (or other validation nodes), client node 1102 can be given a certain level of permissions. As another example, if distributed ledger node 1110 were to have the capability to update mapping 1112, distributed ledger node 1110 can have a different, higher level of permissions.

System 1100 can include a client device 1114, which can be a network-enabled computer as described herein. In some examples, distributed ledger node 1114 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 1114 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1114 can be in data communication with another network-enabled computer not shown in FIG. 11, such as a smart card (e.g., a contactless card or a contact-based card).

In some examples, client device 1114 can execute one or more applications, such as software applications, that enable, for example, network communications with one or more components of system 1100, transmit and/or receive data, and perform the functions and processes described herein.

In some examples, upon receipt of an authentication request, client device 1114 can call (e.g., via an API) client node 1102. The call can include a routing number and/or an applet or software version number, and client node 1102 can query distributed ledger node 1110 and mapping 1112. Once the query returns the identification of a validation node (e.g., validation node 1108) and/or a validation node address associated with that routing number and/or applet or software version, client node 1102 can reply to client device 1114. Client device 1114 can then proceed with authentication with the validation node. The authentication can be performed by, e.g., the systems and methods described herein, such as by the generation, encryption, transmission, decryption, and validation of a cryptogram as described herein.

In some examples, client node 1102 can be co-resident with validation node 1108. In these examples, client node 1102 can handle the authentication in a single call from client device 1114. In some examples, this can be acceptable only if it is permissible for the full authentication transmission (e.g., a cryptogram as described herein) to be sent to client nodes that are not involved in authentication.

In some examples, if client node 1102 receives, from client device 1114, a routing number that is not handled by its location, client node 1102 can return a code indicating that this routing number is not handled, along with validation node address for the responsible validation node. Client device 1114 can then send the full authentication transmission to validation node 1108 using the received validation node address.

In some examples, client node 1102 can enter the distributed network with different permissions. For example, client node 1102 can be a read-only router of data. As another example, client node 1102 can have permission to send messages to distributed ledger node 1110 updating one or more routing paths for one or more routing numbers. However, client node 1102 would be prevented from updating one or more routing paths for one or more routing numbers for other entities that control other routing numbers which are not associated with client node 1102 or that did not grant this permission. As another example, distributed ledger node 1110 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1102, distributed ledger node 1110, and/or validation node 1108, if security, legal, and/or financial conditions are met, however, delegation is not required.

In some examples, one or more APIs can facilitate communication between components of system 1100 via network 1106. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1108 for authentication, can require storage of the keys in one or more HSMs, to promote key security and ensure that the keys are never entered into memory.

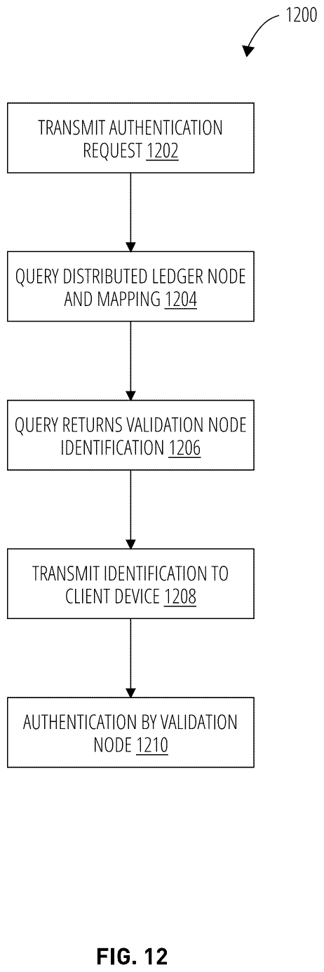

FIG. 12 illustrates a method 1200 performed by a distributed network authentication system according to an example embodiment. For example, the method can be performed by distributed network authentication system 1100 and or by another distributed network authentication system.

In block 1202, a client device can transmit an authentication request to a client node. The authentication request can include, without limitation, a routing number, a software version number, and/or an applet version number. The request can be made by an API call or other communication between the client device and the client node.

In block 1204, after receiving the authentication request, the client node can transmit a query (e.g., via an API call) to a distributed ledger node. The distributed ledger node contain a mapping, and the distributed ledger node can submit the query to the mapping.

In block 1206, the query can return an identification of a validation node and/or a validation node address, and the distributed ledger node can transmit this identification to the client node.

In block 1208, the client node can transmit the identification to the client device. After receiving the identification, the client device can proceed with authentication with the identified validation node and/or validation node address, in block 1210.

FIG. 13 illustrates a data transmission system 1300 according to an example embodiment. As further discussed below, system 1300 may include contactless card 1302, client device 1304, network 1306, and server 1308. Although FIG. 13 illustrates single instances of the components, system 1300 may include any number of components.

System 1300 may include one or more contactless cards 1302, which are further explained below. In some embodiments, contactless card 1302 may be in wireless communication, utilizing NFC in an example, with client device 1304.

System 1300 may include client device 1304, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 1304 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 1304 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 1304 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 1304 of system 1300 may execute one or more applications, such as software applications, that enable, for example, network communications with one or more components of system 1300 and transmit and/or receive data.

The client device 1304 may be in communication with one or more server(s) 1308 via one or more network(s) 1306, and may operate as a respective front-end to back-end pair with server 1308. The client device 1304 may transmit, for example from a mobile device application executing on client device 1304, one or more requests to server 1308. The one or more requests may be associated with retrieving data from server 1308. The server 1308 may receive the one or more requests from client device 1304. Based on the one or more requests from client device 1304, server 1308 may be configured to retrieve the requested data from one or more databases (not shown). Based on receipt of the requested data from the one or more databases, server 1308 may be configured to transmit the received data to client device 1304, the received data being responsive to one or more requests.

System 1300 may include one or more networks 1306. In some examples, network 1306 may be one or more of a wireless network, a wired network or any combination of wireless network and wired network, and may be configured to connect client device 1304 to server 1308. For example, network 1306 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 1306 may include, without limitation, telephone lines, fiber optics, IEEE Ethernet 802.3, a wide area network, a wireless personal area network, a LAN, or a global network such as the Internet. In addition, network 1306 may support an Internet network, a wireless communication network, a cellular network, or the like, or any combination thereof. network 1306 may further include one network, or any number of the exemplary types of networks mentioned above, operating as a stand-alone network or in cooperation with each other. network 1306 may utilize one or more protocols of one or more network elements to which they are communicatively coupled. network 1306 may translate to or from other protocols to one or more protocols of network devices. Although network 1306 is depicted as a single network, it should be appreciated that according to one or more examples, network 1306 may comprise a plurality of interconnected networks, such as, for example, the Internet, a service provider's network, a cable television network, corporate networks, such as credit card association networks, and home networks.

System 1300 may include one or more servers 1308. In some examples, server 1308 may include one or more processors, which are coupled to memory. The server 1308 may be configured as a central system, server or platform to control and call various data at different times to execute a plurality of workflow actions. Server 1308 may be configured to connect to the one or more databases. The server 1308 may be connected to at least one client device 1304.

FIG. 14 illustrates an example configuration of a contactless card 1302, which may include a contactless card, a payment card, such as a credit card, debit card, or gift card, issued by a service provider as displayed as service provider indicia 1402 on the front or back of the contactless card 1302. In some examples, the contactless card 1302 is not related to a payment card, and may include, without limitation, an identification card. In some examples, the transaction card may include a dual interface contactless payment card, a rewards card, and so forth. The contactless card 1302 may include a substrate 1408, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 1302 may have physical characteristics compliant with the ID-1 format of the ISO/IEC 7816 standard, and the transaction card may otherwise be compliant with the ISO/IEC 14443 standard. However, it is understood that the contactless card 1302 according to the present disclosure may have different characteristics, and the present disclosure does not require a transaction card to be implemented in a payment card.

The contactless card 1302 may also include identification information 1406 displayed on the front and/or back of the card, and a contact pad 1404. The contact pad 1404 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 1302 may also include processing circuitry, antenna and other components as will be further discussed in FIG. 15. These components may be located behind the contact pad 1404 or elsewhere on the substrate 1408, e.g. within a different layer of the substrate 1408, and may electrically and physically coupled with the contact pad 1404. The contactless card 1302 may also include a magnetic strip or tape, which may be located on the back of the card (not shown in FIG. 14). The contactless card 1302 may also include a Near-Field Communication (NFC) device coupled with an antenna capable of communicating via the NFC protocol. Embodiments are not limited in this manner.

FIG. 15 illustrates a contactless card component 1500 of the contactless card 1302 shown in FIG. 14. As illustrated in FIG. 15, the contact pad 1404 of contactless card 1302 may include processing circuitry 1516 for storing, processing, and communicating information, including a processor 1502, a memory 1504, and one or more interface(s) 1506. It is understood that the processing circuitry 1516 may contain additional components, including processors, memories, error and parity/CRC checkers, data encoders, anticollision algorithms, controllers, command decoders, security primitives and tamperproofing hardware, as necessary to perform the functions described herein.

The memory 1504 may be a read-only memory, write-once read-multiple memory or read/write memory, e.g., RAM, ROM, and EEPROM, and the contactless card 1302 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 1504 may be encrypted memory utilizing an encryption algorithm executed by the processor 1502 to encrypted data.

The memory 1504 may be configured to store one or more applet(s) 1508, one or more counter(s) 1510, a customer identifier 1514, and the account number(s) 1512, which may be virtual account numbers. The one or more applet(s) 1508 may comprise one or more software applications configured to execute on one or more contactless cards, such as a Java® Card applet. However, it is understood that applet(s) 1508 are not limited to Java Card applets, and instead may be any software application operable on contactless cards or other devices having limited memory. The one or more counter(s) 1510 may comprise a numeric counter sufficient to store an integer. The customer identifier 1514 may comprise a unique alphanumeric identifier assigned to a user of the contactless card 1302, and the identifier may distinguish the user of the contactless card from other contactless card users. In some examples, the customer identifier 1514 may identify both a customer and an account assigned to that customer and may further identify the contactless card 1302 associated with the customer's account. As stated, the account number(s) 1512 may include thousands of one-time use virtual account numbers associated with the contactless card 1302. An applet(s) 1508 of the contactless card 1302 may be configured to manage the account number(s) 1512 (e.g., to select an account number(s) 1512, mark the selected account number(s) 1512 as used, and transmit the account number(s) 1512 to a mobile device or a client device 1304 for autofilling by an autofilling service.

In some embodiments, the memory 1504 can include (e.g., have stored therein) the data from the fields shown in FIG. 9. The processor 1502 can then use the data from the fields to generate the message 900 as described above.

The processor 1502 and memory elements of the foregoing exemplary embodiments are described with reference to the contact pad 1404, but the present disclosure is not limited thereto. It is understood that these elements may be implemented outside of the contact pad 1404 or entirely separate from it, or as further elements in addition to processor 1502 and memory 1504 elements located within the contact pad 1404.

In some examples, the contactless card 1302 may comprise one or more antenna(s) 1518. The one or more antenna(s) 1518 may be placed within the contactless card 1302 and around the processing circuitry 1516 of the contact pad 1404. For example, the one or more antenna(s) 1518 may be integral with the processing circuitry 1516 and the one or more antenna(s) 1518 may be used with an external booster coil. As another example, the one or more antenna(s) 1518 may be external to the contact pad 1404 and the processing circuitry 1516.

In an embodiment, the coil of contactless card 1302 may act as the secondary of an air core transformer. The terminal may communicate with the contactless card 1302 by cutting power or amplitude modulation. The contactless card 1302 may infer the data transmitted from the terminal using the gaps in the contactless card's power connection, which may be functionally maintained through one or more capacitors. The contactless card 1302 may communicate back by switching a load on the contactless card's coil or load modulation. Load modulation may be detected in the terminal's coil through interference. More generally, using the antenna(s) 1518, processor 1502, and/or the memory 1504, the contactless card 1302 provides a communications interface to communicate via NFC, Bluetooth, and/or Wi-Fi communications.

As explained above, contactless card 1302 may be built on a software platform operable on smart cards or other devices having limited memory, such as JavaCard, and one or more or more applications or applets may be securely executed. Applet(s) 1508 may be added to contactless cards to provide a one-time password (OTP) for multifactor authentication (MFA) in various mobile application-based use cases. Applet(s) 1508 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 1508 may be configured to encode the OTP as an NDEF type 4 well known type text tag. In some examples, NDEF messages may comprise one or more records. The applet(s) 1508 may be configured to add one or more static tag records in addition to the OTP record.

In some examples, the one or more applet(s) 1508 may be configured to emulate an RFID tag. The RFID tag may include one or more polymorphic tags. In some examples, each time the tag is read, different cryptographic data is presented that may indicate the authenticity of the contactless card. Based on the one or more applet(s) 1508, an NFC read of the tag may be processed, the data may be transmitted to a server, such as a server of a banking system, and the data may be validated at the server.

In some examples, the contactless card 1302 and server may include certain data such that the card may be properly identified. The contactless card 1302 may include one or more unique identifiers (not pictured). Each time a read operation takes place, the counter(s) 1510 may be configured to increment. In some examples, each time data from the contactless card 1302 is read (e.g., by a mobile device), the counter(s) 1510 is transmitted to the server for validation and determines whether the counter(s) 1510 are equal (as part of the validation) to a counter of the server.

The one or more counter(s) 1510 may be configured to prevent a replay attack. For example, if a cryptogram has been obtained and replayed, that cryptogram is immediately rejected if the counter(s) 1510 has been read or used or otherwise passed over. If the counter(s) 1510 has not been used, it may be replayed. In some examples, the counter that is incremented on the card is different from the counter that is incremented for transactions. The contactless card 1302 is unable to determine the application transaction counter(s) 1510 since there is no communication between applet(s) 1508 on the contactless card 1302.

In some examples, the counter(s) 1510 may get out of sync. In some examples, to account for accidental reads that initiate transactions, such as reading at an angle, the counter(s) 1510 may increment but the application does not process the counter(s) 1510. In some examples, when the client device 1304 is woken up, NFC may be enabled and the client device 1304 may be configured to read available tags, but no action is taken responsive to the reads.

To keep the counter(s) 1510 in sync, an application, such as a background application, may be executed that would be configured to detect when the mobile client device 1304 wakes up and synchronize with the server of a banking system indicating that a read that occurred due to detection to then move the counter(s) 1510 forward. In other examples, Hashed One Time Password may be utilized such that a window of mis-synchronization may be accepted. For example, if within a threshold of 10, the counter(s) 1510 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 1510 increases in the appropriate sequence, then it possible to know that the user has done so.

The key diversification technique described herein with reference to the counter(s) 1510, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 1302, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 1302. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 1302 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

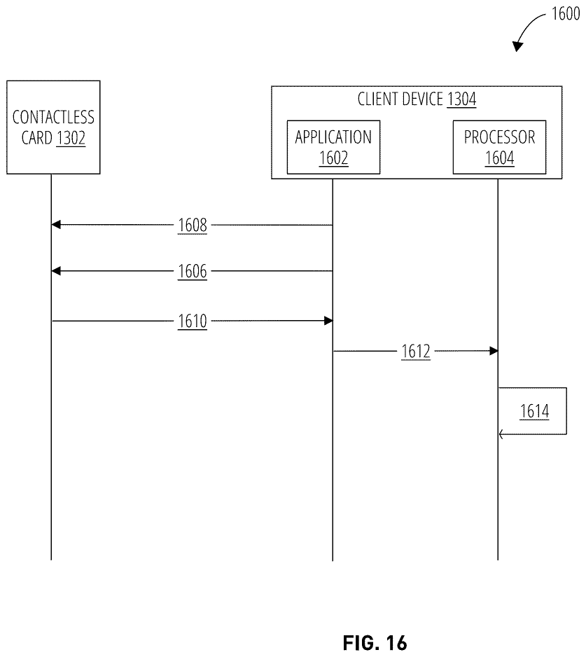

FIG. 16 is a timing diagram illustrating an example sequence for providing authenticated access according to one or more embodiments of the present disclosure. Sequence flow 1600 may include contactless card 1302 and client device 1304, which may include an application 1602 and processor 1604.

At line 1608, the application 1602 communicates with the contactless card 1302 (e.g., after being brought near the contactless card 1302). Communication between the application 1602 and the contactless card 1302 may involve the contactless card 1302 being sufficiently close to a card reader (not shown) of the client device 1304 to enable NFC data transfer between the application 1602 and the contactless card 1302.

At line 1606, after communication has been established between client device 1304 and contactless card 1302, contactless card 1302 generates a message authentication code (MAC) cryptogram. In some examples, this may occur when the contactless card 1302 is read by the application 1602. In particular, this may occur upon a read, such as an NFC read, of a near field data exchange (NDEF) tag, which may be created in accordance with the NFC Data Exchange Format. For example, a reader application, such as application 1602, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 1302 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1602 may be configured to transmit a request to contactless card 1302, the request comprising an instruction to generate a MAC cryptogram.

At line 1610, the contactless card 1302 sends the MAC cryptogram to the application 1602. In some examples, the transmission of the MAC cryptogram occurs via NFC, however, the present disclosure is not limited thereto. In other examples, this communication may occur via Bluetooth, Wi-Fi, or other means of wireless data communication. At line 1612, the application 1602 communicates the MAC cryptogram to the processor 1604.

At line 1614, the processor 1604 verifies the MAC cryptogram pursuant to an instruction from the application 1602. For example, the MAC cryptogram may be verified, as explained below. In some examples, verifying the MAC cryptogram may be performed by a device other than client device 1304, such as a server of a banking system in data communication with the client device 1304. For example, processor 1604 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

1. A chip card, comprising:
a processor coupled with a memory comprising one or more applets, an antenna, a transducer, and a power storage device comprising a capacitor, a battery, or a combination of the capacitor and the battery, the processor to execute instructions of the one or more applets to perform operations to:
communicate via an electromagnetic field in accordance with a wireless power transfer protocol to indicate a charge level of the power storage device;
receive power via the electromagnetic field to store in the power storage device after the charge level is below a predetermined charge level;
detect a first trigger event, wherein the first trigger event comprises disconnection of a source of power to charge the power storage device, loss of communication with a mobile device, or completion of a transaction; and
cause application of periodic power pulses to the transducer to generate ultrasonic signals based on power stored in the power storage device after the first trigger event.

2. The chip card of claim 1, wherein the one or more applets comprise a metal detection applet, the processor to execute the metal detection applet to generate an electromagnetic frequency (EMF) signal, to receive reflections of the EMF signal from a conductive metal shield via the antenna, and to determine, based on received signals, that the received signals comprise reflections of the EMF signal off the conductive metal shield.

3. The chip card of claim 1, further comprising a communications interface, wherein the communications interface comprises a near field communications interface, a contacted communications interface, a wireless communications interface, or a combination thereof.

4. The chip card of claim 3, the power storage device to charge via the contacted communications interface.

5. The chip card of claim 3, further comprising energy harvesting circuitry to harvest energy to charge the power storage device from oscillating electromagnetic energy received from the mobile device, a card terminal, or another device.

6. The chip card of claim 1, further comprising a second trigger event, the second trigger event based on a power threshold of the power storage device, wherein the processor reduces a frequency of the periodic power pulses to the transducer to reduce power consumption.

7. A mobile device, comprising:
a processor coupled with a near-field communications interface, a power storage device, a microphone, a speaker, a display, and a memory comprising one or more applets, the processor to execute the one or more applets to perform operations to:
generate, via a sound signaling application in the memory and the near-field communications interface, an electromagnetic field proximate to the chip card via a wireless power transfer protocol;
communicate with the chip card via the electromagnetic field in accordance with the wireless power transfer protocol to determine a charge level of the power storage device;
transfer power to the power storage device after a determination that the charge level is below a predetermined charge level;
monitor, via the sound signaling application, the microphone for ultrasonic pulses from chip card;
determine, based on receipt of the ultrasonic pulses, variations in an intensity of the ultrasonic pulses; and
generate, via the sound signaling application, a representation of the variations in the intensity of the ultrasonic pulses, the representation comprising a visual representation, an audible representation, or a combination thereof;
present the representation via the display, the speaker, or a combination thereof.

8. The mobile device of claim 7, the operations to further determine, based on a periodicity of the ultrasonic pulses, that the ultrasonic pulses are generated by the chip card.

9. The mobile device of claim 7, the operations to further:
detect a presence of the chip card in proximity to the mobile device;
determine a location of the mobile device via a location device or an applet; and
store an indication of the location in the memory to maintain one or more prior locations of the chip card in the memory including a last known location of the chip card.

10. The mobile device of claim 9, the operations to further detect an absence of the chip card within a proximity about the mobile device.

11. The mobile device of claim 10, the operations to further generate an audible alert via the speaker after the detection of the absence of the chip card within the proximity about the mobile device; generate a visual alert via the display after the detection of the absence of the chip card within the proximity about the mobile device, wherein the visual alert comprises a display of the last known location prior to the detection of the absence of the chip card within the proximity about the mobile device; or a combination thereof.

12. The mobile device of claim 11, wherein generation of the visual alert comprises operation to generate an indication of a location on a map to present a geographical location of the last known location.

13. The mobile device of claim 11, wherein generation of the visual alert comprises operation to generate a pointer on the display to indicate a direction of the last known location relative to a current location of the mobile device.

14. The mobile device of claim 10, the operations to further triangulate a location of the chip card relative to the mobile device based on receipt of ultrasonic pulses from the chip card and to present a pointer on the display indicative of the location of the chip card relative to a current location of the mobile device.

15. The mobile device of claim 9, the operations to further generate an oscillating electromagnetic field to charge a power storage device of the chip card while the chip card is proximate to the mobile device.

16. A computer-implemented method, comprising:
determining, by a processor of a chip card executing an applet from memory coupled with the processor, an occurrence of a first trigger event, wherein the first trigger event comprises disconnection of a source of power to charge a power storage device, loss of communication with a mobile device, or completion of a transaction;
determining, based on generation of an electromagnetic frequency (EMF) signal, whether the EMF signal is reflected off a conductive metal shield; and
causing application of periodic current pulses to a transducer to generate periodic ultrasonic pulses via on power stored in the power storage device after the occurrence of the first trigger event and a determination that the EMF signal is not reflected off the conductive metal shield.

17. The computer-implemented method of claim 16, wherein determining whether the EMF signal is reflected off the conductive metal shield comprises executing a metal detection applet to generate the electromagnetic frequency (EMF) signal, to receive reflections of the EMF signal from a conductive metal shield via an antenna coupled with the processor, and to determine, based on received signals, that the received signals comprise reflections of the EMF signal off the conductive metal shield.

18. The computer-implemented method of claim 16, further comprising determining that the chip card is proximate to the mobile device via a wireless communication interface coupled with the processor, on the chip card.

19. The computer-implemented method of claim 18, further comprising storing energy in the power storage device via energy harvesting circuitry, the energy harvesting circuitry to harvest energy from oscillating electromagnetic energy received from the mobile device, a card terminal, or another device.

20. The computer-implemented method of claim 18, further comprising reducing a frequency of the application of the periodic current pulses to the transducer to reduce power consumption after detection of an occurrence of a second trigger event by the processor, and terminating the periodic power pulses to the transducer after detection of an occurrence of a third trigger event by the processor, wherein detection of the second trigger event comprises determining that a power level of the power storage device is at or below a first threshold, wherein detection of the third trigger event comprises determining that a power level of the power storage device is at or below a second threshold, determining that the chip card is proximate to a conductive metal shield, detecting that contacts of the chip card are in electrical contact with other contacts, determining that the chip card is proximate to the mobile device, determining that the power storage device is charging, or a combination thereof.
